(19) United States
(12) Patent Application Publication
(10) Pub. No.: US 2003/0217052 A1
(43) Pub. Date: Nov. 20, 2003

(54) Search engine method and apparatus

(75) Inventors: Tal Rubenczyk, Tel Aviv (IL); Nachum Dershowitz, Tel-Aviv (IL); Yaacov Choueka, Jerusalem (IL); Michael Flor, Kfar Gibton (IL); Oren Hod, Haifa (IL); Assaf Roth, Tel-Aviv (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Celebros Ltd.

(21) Appl. No.: 10/436,996

(22) Filed: May 14, 2003

Related U.S. Application Data
(63) Continuation of application No. 10/362,095.
Application No. 10/362,095 is a 371 of international application No. PCT/IL01/00786, filed on Aug. 22, 2001.
(60) Provisional application No. 60/227,356, filed on Aug. 24, 2000.

(30) Foreign Application Priority Data
Dec. 11, 2000 (IL) 140241

(51) Int. Cl. G06F 7/00

(52) U.S. Cl. 707/3

(57) ABSTRACT

An interactive method for searching a database to produce a refined results space, the method comprising: analyzing for search criteria, searching said database using said search criteria to obtain an initial result space, and obtaining user input to restrict said initial results space, thereby to obtain said refined results space. Refining comprises using classifications of the retrieved data items to formulate prompts for the user, asking said user at least one of the formulated prompts and receiving a response thereto; and using responses in conjunction with classification values to exclude some of the results, thereby to provide to the user a subset of the retrieved data items as a query result.

### RELATIONSHIP TO EXISTING APPLICATIONS

The present application is a continuation in part of U.S. patent application Ser. No. 10/362,095 filed Feb. 21, 2003 as the US National Phase of PCT/IL01/00786 filed Aug. 22, 2001, which in turn claims priority from U.S. Patent Application No. 60/227,356 filed Aug. 24, 2000, and Israel Patent Application No. 140,241 filed Dec. 11, 2000.

### FIELD AND BACKGROUND OF THE INVENTION

The present invention relates to a search engine and, more particularly, but not exclusively to a search engine for use in conjunction with databases including networked databases and information stores.

Information Retrieval (IR) systems and the Search Engines (SE) associated with them have been under study and development since the early sixties. However, the role they play, their importance and the critical impact they have on the effectiveness of computerized information systems have dramatically increased with the advent of the Internet and Intranet worlds and the mind-boggling amount of information and services available through these avenues. Typical examples of how search engines are used on the Internet include the following:

A researcher searches for information that is presumably available somewhere on the Internet on a very specific topic, for example solar energy or British folk songs, using a common SE such as Google, AltaVista, Lycos, etc.

A consumer wishes to buy a specific product, such as a shirt, a digital camera or a book through a portal of e-vendors such as Yahoo, or through a specific vendor e-site. The consumer relies on the portal or the site SE to accurately locate the requested product.

An employee in a large enterprise looks for specific data in the huge enterprise text warehouse, relying on a search engine specific to the enterprise to bring him, in no time, precisely what he had in mind.

Obviously, these disparate needs are compounded by various degrees of user sophistication. On the other hand, user tenacity in looking for the desired information and reactions to receiving incomplete or erroneous results, can only be surmised. It is likely though, that due to the inadequacies inherent in today's SEs, in the examples above, the user will often become frustrated and will finally develop negative attitudes towards the abilities of information retrieval, may even stop using information retrieval altogether and resultant lack of use may indirectly contribute to degeneration or atrophy of data bases that it ceases to be worthwhile to maintain.

Crucial as they are for the successful operations described above, most currently available SEs suffer from acute problems of accuracy or precision, coverage and focus, that severely hinder their performance and the adequate functioning of the operations they are designed to support. Searches generally treat input queries as lists of keywords, and search for best matches to the list of keywords without significantly taking into account intended meanings or relationships between meanings. Thus a well-known search engine counts as one of its most advanced features the ability to recognize that certain well-known word pairs such as “San Francisco” and “New York” should be treated as single terms.

Often, items, that is potential objects of a search, that are represented in a database or data store or Information Storehouse (IS) component of an IR system, are in the form of free-text documents, The documents can be very short (just one line, as in the name of a product in an e-vendor site), of medium length (a few lines, as in a news item) or quite long (a few pages, as in financial reports, scientific articles, or encyclopedic entries). Still, it should be strongly emphasized that the textual medium, though definitively the most common one today, is by no means the only applicable medium for database items. The IS can consist of items that are pictures, videos, sound excerpts, electronically transcribed music sheets, or any other resource that contains information. The query may then consist of describing parts or features of the required pictures (colors, shapes, etc.) or sounds, a short musical or rhythmic pattern, and the like.

As a background to the specific embodiment discussed, some comments are provided on the field of electronic commerce, hereinafter the e-commerce context (ECC). In the present context, the IS is a huge storehouse of product names, pictures and descriptions, and the query is a request submitted by the user in the form of a textual string that describes (probably imperfectly) his desiderata.

The reason why the EC context was chosen is three-fold:

a) Electronic commerce is experiencing exponential growth and shows great potential,

b) Good SEs are essential to successful operation, on the basis that users will not purchase something they cannot find. In particular, if a user can only find approximately what he wants he is unlikely to make a purchase now and is less likely to try electronic commerce for a future purchase, and

c) Available SEs fall short of what is needed to allow precise location of desired products based on typical, that is unskilled, user input.

The following quotations, among many others, support the above observations:

a) On the potential of the e-retail domain:

“By the end of 2002, more than 600 million people worldwide will have access to the Web, and they will spend more than US $1 trillion shopping online” (Feb. 13, 2001, Newsfactor.com, in “E-commerce to top $1 trillion shopping online”).

“Is there a future for e-tailing? At Booz-Allen, our answer is a resounding yes! Growth potential in this segment is enormous” (3/2001, ebusinessforum, Booz-Allen & Hamilton).

b) On the importance of good SEs for this application:

“More than half of online buyers use search to find products—and the better the search tools, the more they buy”, . . . , “Every time we added a capability on search, bidding went way up”, . . . , “Sites that ignore the importance of search are losing sales without ever realizing it” (Sep. 24, 2001, Businessweek.com, in “Desperately seeking search technology”).

“80% of online users will abandon a site if the search function doesn't work well” (Nov. 28, 2001, webmastrcase.com, in “Secrets to site search success”).

c) On the current situation:

“You could make a case that the main reason e-commerce is unprofitable is that the power of search has been overlooked . . . a good search capability can help turn that situation around” (Sep. 24, 2001, Seybold Group, Businessweek.com, in “Desperately seeking Search technology”).

“The most common factor that stopped users from buying on a site was that they couldn't find the item they were looking for. This accounted for 27 percent of all lost sales in our study. And when they used a site's search function to try to find items, the failure rate was even higher—a full 36 percent of users couldn't find what they wanted” (February 2001, webtechniques.com, in “Building web sites with depth”).

“Sometimes shoppers just want to search for the item, locate it quickly and check out. Unfortunately, most e-tail sites use older search technology that isn't always efficient and is often frustrating to use” (Mar. 28, 2001, professionaljeweler.com).

“More than two-thirds of online retail sites tested last spring by Forrester Research failed to list the most relevant content in the first page of search results. No wonder sites have suffered from an inability to convert browsers into buyers. Customers are literally being driven away by weak search technology” (Feb. 28, 2001, nytimes.com, in “Revving-up the search engines to keep the E-Aisles clear”, by Lisa Guernsey).

Information Retrieval System

In its most general and basic form, an IR system consists of two components:

a) an Information Storehouse of a few thousand to a few million (and sometimes even tens of millions) of items; and

b) a Search Engine that can process a-given query—couched in a free-flow natural language, or in some pre-determined formal language, or even as a choice from a menu, a map, or a given catalogue—and that returns the group of items from the IS that are judged by the system to be relevant to the user query. The retrieved items can be presented either as an unorganized set or as an ordered list, sorted by some meta-data criterion such as date, author or price, or, more to the point, by the item's rank score (from best to poorest) that allegedly measures its closeness to the user request. The results can then be presented either as pointers (or references) to the pertinent items, or by displaying these items in full, or, finally by displaying only selected parts of these items, those that are judged by the system to be the most interesting ones to the user.

Several enhancements of this basic paradigm have been proposed, and to a certain extent, also implemented in later generations of SEs. Thus, the items in an IS can be pre-processed by annotating them with useful data, such as keywords or descriptors, that may enhance the query/item matching chances of success. Further, the query itself can be subjected to a clarification process where spelling errors are recognized and corrected and where synonyms are recognized and attached to some of the query's parts. The user can refine his search by engaging in a second search based on the results of his original query. Finally, the results can be presented in a more coherent structure, i.e. as a tree or a hierarchical structure, either in a pre-defined way, or through an “on-the-fly” clustering of the top results.

In the retrieval context, the above-described scheme still leaves a number of problems unsolved; a few of which are listed below.

1. A specific item in the IS may match the query-specified desiderata and still not be retrieved because the description of the relevant item does not contain the exact terms specified by the user in the query but some other related ones; these can be synonyms or quasi-synonyms (pants/trousers), acronyms and abbreviations (tv/television), more general terms (rose/flowers), more specific ones (shirt/t-shirt), etc.; coverage is therefore affected.

2. The process may mistakenly retrieve items that contain (some of) the query terms, but that nonetheless do not satisfy the query conditions. Thus a “television” product might be retrieved for “tv antenna”, or, vice-versa, a “tablecloth clamp” might be displayed for a “tablecloth” request, affecting the precision of the system.

3. Prepositions that occur in the query such as “for”, “from”, “by”, even more so terms such as “not’“and”, “or” that can be interpreted as operators, sometimes even specific punctuation—if not properly analyzed and accounted for—can completely reverse the query interpretation.

4. Values of appropriate attributes explicitly mentioned in the query, such as “red or “blue”(or “red and blue”) for colors, “silk” or “wool” for material, etc. must be carefully checked and matched in the items that the system identifies as potentially appropriate results to the query. This may be quite a complicated process since the corresponding attribute-value in the item may be only implicitly hinted at in the information available in the IS on this particular item.

5. Ambiguous queries need to be resolved in order to support a reasonable search that does not retrieve entirely redundant material. Does the word “records” in a query refer to recordings of music or to Guinness-type records? Does the word “glasses” refer to cups or to spectacles? Disambiguation can be an intricate problem in particular when the ambiguity crosses different dimensions, such as in the case of “gold” which can specify a color, a product (e.g., a watch) attribute, or the material itself. Ambiguity can be also syntactical and not lexical, as in “red shirts and pants.”

6. What if there are no items that satisfy all aspects of the user's request, but only parts of them? How is the system to determine which conditions are more important than others? What if the query is only partially articulated, such as giving only a brand name? Can the SE intelligently handle an empty query?

7. A common problem in SEs is that a very large quantity of information can be returned as a result of a single query. Such a quantity is often unmanageable by a human user, who simply looks through the first few pages of results. Highly relevant results can often be missed simply because they appear on the tenth or fiftieth page. For example a search for “atomic energy” using Google returns more than a million results! More modestly, but still unmanageable, is a search for “shirts” in Yahoo! Shopping, which returns more than 70,000 products! What is a reasonable user expected to do with such results?

There is thus a widely recognized need for, and it would be highly advantageous to have, a search engine devoid of the above limitations.

### SUMMARY OF THE INVENTION

According to one aspect of the present invention there is provided an interactive method for searching a database to produce a refined results space, the method comprising:

analyzing for search criteria,

searching the database using the search criteria to obtain an initial result space, and

obtaining user input to restrict the initial results space, thereby to obtain the refined results space.

Preferably, the searching comprises browsing.

Preferably, the analyzing is performed on the database prior to searching, thereby to optimize the database for the searching.

Additionally or alternatively, the analyzing is performed on a search criterion input by a user.

Preferably, the analyzing comprises using linguistic analysis.

The method preferably involves carrying out analyzing on an initial search criterion to obtain an additional search criterion.

In one embodiment, a null criterion is acceptable as a search criterion, in which case the method proceeds by generating a series of questions to obtain search criteria from the user.

Preferably, the analyzing for additional search criteria is carried out using linguistic analysis of the initial search criterion.

Preferably, the analyzing is carried out by selection of related concepts.

Preferably, the analyzing is carried out using data obtained from past operation of the method.

The method preferably involves generating a prompt for the obtaining user input, by generating at least one prompt having at least two answers, the answers being selected to divide the initial results space.

Preferably, the generating a prompt comprises generating at least one segmenting prompt having a plurality of potential answers, each answer corresponding to a part of the results space.

Preferably, each part of the results space, as defined by the potentional answers to the prompts, comprises a substantially proportionate share of the results space.

The method preferably involves generating a plurality of segmenting prompts and choosing therefrom a prompt whose answers most evenly divide the results space.

Preferably, the restricting the results space comprises rejecting, from the results space, any results not corresponding to an answer given in the user input.

The method preferably involves allowing a user to insert additional text, the text being usable as part of the user input in the restricting.

The method preferably allows a stage of repeating the obtaining of user input by generating at least one further prompt having at least two answers, the answers being selected to divide the refined results space.

A preferred embodiment allows continuing of the restricting until the refined results space is contracted to a predetermined size.

Additionally or alternatively, the method may allow such continuing of the restricting until no further prompts are found.

Additionally or alternatively, the method may allow continuing the restricting until a user input is received to stop further restriction and submit the existing results space.

The method may comprise determining that a submitted results space does not include a desired item, and following the determination, may submit to the user initially retrieved items that have been excluded by the restricting.

The method preferably involves carrying out stages of:

obtaining from a user a determination that a submitted results space does not include a desired item, and

submitting to the user initially retrieved items that have been excluded by the restricting.

The method preferably involves receiving the initial search criterion as user input.

Preferably, the obtaining the user input includes providing a possibility for a user not to select an answer to the prompt.

The method may include providing an additional prompt following non-selection of an answer by the user. For example the same question can be asked in a different way, or can be replaced by an alternative question.

The method preferably involves carrying out updating of the system internal search-supporting information according to a final selection of an item by a user following a query.

The updating may comprise modifying a correlation between the selected item and the obtained user input.

According to a second aspect of the present invention there is provided apparatus for interactively searching a database to produce a refined results space, comprising:

a search criterion analyzer for analyzing to obtain search criteria,

a database searcher, associated with the search criterion analyzer, for searching the database using the search criteria to obtain an initial result space, and

a restrictor, for obtaining user input to restrict the results space, and using the user input to restrict the results space, thereby to formulate a refined results space.

Preferably, the search criterion analyzer comprises a database data-items analyzer capable of producing classifications for data items to correspond with analyzed search criteria.

Preferably, the search criterion analyzer comprises a database data-items analyzer capable of utilizing classifications for data items to correspond with analyzed search criteria.

Preferably, the search criterion analyzer is further capable of utilizing classifications for data items to correspond with analyzed search criteria.

Preferably, the database data items analyzer is operable to analyze at least part of the database prior to the search.

Preferably, the database data items analyzer is operable to analyze at least part of the database during the search.

Preferably, the analyzing comprises linguistic analysis.

Preferably, the analyzing comprises statistical analysis.

Preferably, the statistical analysis comprises statistical language-analysis.

Preferably, the search criterion analyzer is configured to receive an initial search criterion from a user for the analyzing.

Preferably, the initial search criterion is a null criterion.

Preferably, the analyzer is configured to carry out linguistic analysis of the initial search criterion.

Preferably, the analyzer is configured to carry out an analysis based on selection of related concepts.

Preferably, the analyzer is configured to carry out an analysis based on historical knowledge obtained over previous searches.

Preferably, the restrictor is operable to generate a prompt for the obtaining user input, the prompt comprising at least two selectable responses, the responses being usable to divide the initial results space.

Preferably, the prompt comprises a segmenting prompt having a plurality of potential answers, each answer corresponding to a part of the results space, and each part comprising a substantially proportionate share of the results space.

Preferably, generating the prompt comprises

generating a plurality of segmenting prompts, each having a plurality of potential answers, each answer corresponding to a part of the results space, and each part comprising a substantially proportionate share of the results space, and

selecting one of the prompts whose answers most evenly divide the results space.

The apparatus may be configured to allow a user to insert additional text, the text being usable as part of the user input by the restrictor.

Preferably, the restricting the results space comprises rejecting therefrom any results not corresponding to an answer given in the user input, thereby to generate a revised results space.

Preferably, the restrictor is operable to generate at least one further prompt having at least two answers, the answers being selected to divide the revised results space.

Preferably, the restrictor is configured to continue the restricting until the refined results space is contracted to a predetermined size.

Additionally or alternatively, the restrictor is configured to continue the restricting until no further prompts are found.

Additionally or alternatively, the restrictor is configured to continue the restricting until a user input is received to stop further restriction and submit the existing results space.

Preferably, a user is enabled to respond that a submitted results space does not include a desired item, the apparatus being configured to submit to the user initially retrieved items that have been excluded by the restricting, in receipt of such a response.

The apparatus may be configured to determine that a submitted results space does not include a desired item, the apparatus being configured, following such a determination, to submit to the user initially retrieved items that have been excluded by the restricting, in receipt of such a response.

Preferably, the analyzer is configured to receive the initial search criterion as user input.

Preferably, the restrictor is configured to provide, with the prompt, a possibility for a user not to select an answer to the prompt.

Preferably, the restrictor is operable to provide a further prompt following non-selection of an answer by the user.

The apparatus may be configured with an updating unit for updating system internal search-supporting information according to a final selection of an item by a user following a query.

Preferably, updating comprises modifying a correlation between the selected item and the obtained user input.

Additionally or alternatively, updating comprises modifying a correlation between a classification of the selected item and the obtained user input.

According to a third aspect of the present invention there is provided a database with apparatus for interactive searching thereof to produce a refined results space, the apparatus comprising:

a search criterion analyzer for analyzing for search criteria,

a database searcher, associated with the search criterion analyzer, for searching the database using search criteria to obtain an initial result space, and

a restrictor, for obtaining user input to restrict the results space, and using the user input to restrict the results space, thereby to provide the refined results space.

Preferably, the search criterion analyzer comprises a database data-items analyzer capable of producing classifications for data items to correspond with analyzed search criteria.

Preferably, the search criterion analyzer comprises a database data-items analyzer capable of utilizing classifications for data items to correspond with analyzed search criteria.

Preferably, the database data items analyzer is further capable of utilizing classifications for data items to correspond with analyzed search criteria.

Preferably, the search criterion analyzer comprises a search criterion analyzer capable of analyzing user-provided search criteria in terms of a classification structure of items in the database.

The database comprises data items and preferably each data item is analyzed into potential search criteria, thereby to optimize matching with user input search criteria.

Preferably, the database data items analyzer is operable to carry out linguistic analysis.

Preferably, the database data items analyzer is operable to carry out statistical analysis, the statistical analysis being statistical language analysis.

Preferably, the search criterion analyzer is configured to receive an initial search criterion from a user for the analyzing.

As discussed above, the initial search criterion may be a null criterion.

Preferably, the analyzer is configured to carry out linguistic analysis of the initial search criterion.

Preferably, the analyzer is configured to carry out an analysis based on selection of related concepts.

Preferably, the analyzer is configured to carry out an analysis based on historical knowledge obtained over previous searches.

Preferably, the restrictor is operable to generate a prompt for the obtaining user input, the prompt comprising a prompt having at least two answers, the answers being selected to divide the initial results space.

Preferably, the prompt is a segmenting prompt having a plurality of potential answers, each answer corresponding to a part of the results space, and each part comprising a substantially proportionate share of the results space.

The database and search apparatus may permit a user to insert additional text, the text being usable as part of the user input by the restrictor.

Preferably, the restricting the results space comprises rejecting therefrom any results not corresponding to one of the answers of the user input, thereby to generate a revised results space.

Preferably, the restrictor is operable to generate at least one further prompt having at least two answers, the answers being selected to divide the revised results space.

Preferably, the restrictor is configured to continue the restricting until the refined results space is contracted to a predetermined size.

Additionally or alternatively, the restrictor is configured to continue the restricting until no further prompts are found.

Additionally or alternatively, the restrictor is configured to continue the restricting until a user input is received to stop further restriction and submit the existing results space.

Preferably, the user is enabled to respond that a submitted results space does not include a desired item, in which case the database and search apparatus are configured to submit to the user initially retrieved items that have been excluded by the restricting.

The database and search apparatus may be configured to determine that a submitted results space does not include a desired item, the database being operable following such a determination to submit to the user initially retrieved items that have been excluded by the restricting.

Preferably, the analyzer is configured to receive the initial search criterion as user input.

Preferably, the restrictor is configured to provide, with the prompt, a possibility for a user not to select an answer to the prompt.

Preferably, the restrictor is further configured to provide an additional prompt following non-selection of an answer by the user.

The database and search apparatus may be configured with an updating unit for updating system internal search-supporting information according to a final selection of an item by a user following a query.

Preferably, the updating comprises modifying a correlation between the selected item and the obtained user input.

Preferably, the updating comprises modifying a correlation between a classification of the selected item and the obtained user input.

According to a fourth aspect of the present invention there is provided a query method for searching stored data items, the method comprising:

i) receiving a query comprising at least a first search term,

ii) expanding the query by adding to the query, terms related to the at least first search term,

iii) retrieving data items corresponding to at least one of the terms,

iv) using attribute values applied to the retrieved data items to formulate prompts for the user,

v) asking the user at least one of the formulated prompts as a prompt for focusing the query,

vi) receiving a response thereto, and

vii) using the received response to compare to values of the attributes to exclude ones of the retrieved items, thereby to provide a subset of the retrieved data items as a query result.

Preferably, the query comprises a plurality of terms, and the expanding the query further comprises analyzing the terms to determine a grammatical interrelationship between ones of the terms.

The query method may comprise using the grammatical interrelationship to identify leading and subsidiary terms of the search query.

Preferably, the expanding comprises a three-stage process of separately adding to the query:

a) items which are closely related to the search term,

b) items which are related to the search term to a lesser degree and

c) an alternative interpretation due to any ambiguity inherent in the search term.

Preferably, the items are one of a group comprising lexical terms and conceptual representations.

The query method may comprise at least one additional focusing process of repeating stages iii) to vi), thereby to provide refined subsets of the retrieved data items as the query result.

The query method may comprise ordering the formulated prompts according to an entropy weighting based on probability values and asking ones of the prompts having more extreme entropy weightings.

The query method may comprise recalculating the probability values and consequently the entropy weightings following receiving of a response to an earlier prompt.

The query method may comprise using a dynamic answer set for each prompt, the dynamic answer set comprising answers associated with classification values, the classification values being true for some received items and false for other received items, thereby to discriminate between the retrieved items.

The query method may comprise ranking respective answers within the dynamic answer set according to a respective power to discriminate between the retrieved items.

The query method may comprise modifying the probability values according to user search behavior.

Preferably, the user search behavior comprises past behavior of a current user.

Additionally or alternatively, the user search behavior comprises past behavior aggregated over a group of users.

Preferably, the modifying comprises using the user search behavior to obtain a priori selection probabilities of respective data items, and modifying the weightings to reflect the probabilities.

Preferably, the entropy weighting is associated with at least one of a group comprising the items classifications of the items and respective classification values.

The query method may comprise semantically analyzing the stored data items prior to the receiving a query.

The query method may comprise semantically analyzing the stored data items during a search session.

Preferably, the semantic analysis comprises classifying the data items into classes.

The query method may comprise classifying attributes into attribute classes.

Preferably, the classifying comprises distinguishing both among object-classes or major classes, and among attribute classes.

Preferably, the classifying comprises providing a plurality of classifications to a single data item.

Preferably, a classification arrangement of respective classes is pre-selected for intrinsic meaning to the subject-matter of a respective database.

The query method may comprise arranging major ones of the classes hierarchically.

The query method may comprise arranging attribute classes hierarchically.

The query method may comprise determining semantic meaning for a term in the data item from a hierarchical arrangement of the term.

Preferably, the classes are also used in analyzing the query.

Preferably, attribute values are assigned weightings according to the subject-matter of a respective database.

Preferably, at least one of the attribute values and the classes are assigned roles in accordance with the subject-matter of a respective database. Roles may for example be a status of data item, or an attribute of a data item.

Preferably, the roles are additionally used in parsing the query.

The query method may comprise assigning importance weightings in accordance with the assigned roles in accordance with the subject-matter of the database.

The query method may comprise using the importance weightings to discriminate between partially satisfied queries.

Preferably, the analysis comprises noun phrase type parsing.

Preferably, the analysis comprises using linguistic techniques supported by a knowledge base related to the subject-matter of the stored data items.

Preferably, the analysis comprises using statistical classification techniques.

Preferably, the analyzing comprises using a combination of:

i) a linguistic technique supported by a knowledge base related to the subject-matter of the stored data items, and

ii) a statistical technique.

Preferably, the statistical technique is carried out on a data item following the linguistic technique.

Preferably, the linguistic technique comprises at least one of:

segmentation,

tokenization,

lemmatization,

tagging,

part of speech tagging, and

at least partial named entity recognition of the data item.

The query method may comprise using at least one of probabilities, and probabilities arranged into weightings, to discriminate between different results from the respective techniques.

The query method may comprise modifying the weightings according to user search behavior.

Preferably, the user search behavior comprises past behavior of a current user.

Additionally or alternatively, the user search behavior comprises past behavior aggregated over a group of users.

Preferably, an output of the linguistic technique is used as an input to the at least one statistical technique.

Preferably, the at least one statistical technique is used within the linguistic technique.

The query method may comprise using two statistical techniques.

The query method may comprise assigning of at least one code indicative of a meaning associated with at least one of the stored data items, the assignment being to terms likely to be found in queries intended for the at least one stored data item.

Preferably, the meaning associated with at least one of the stored data items is at least one of the item, an attribute class of the item and an attribute value of the item.

The query method may comprise expanding a range of the terms likely to be found in queries by assigning a new term to the at least one code.

The query method may comprise providing groupings of class terms and groupings of attribute value terms.

Preferably, if the analysis identifies an ambiguity, then carrying out a stage of testing the query for semantic validity for each meaning within the ambiguity, and for each meaning found to be semantically valid, presenting the user with a prompt to resolve the validity.

Preferably, if the analysis identifies an ambiguity, then carrying out a stage of testing the query for semantic validity to each meaning within the ambiguity, and for each meaning found to be semantically valid then retrieving data items in accordance therewith and discriminating between the meanings based on corresponding data item retrievals.

Preferably, if the analysis identifies an ambiguity, then carrying out a stage of testing the query for semantic validity to each meaning within the ambiguity, and for each meaning found to be semantically valid, using a knowledge base associated with the subject-matter of the stored data items to discriminate between the semantically valid meanings.

The query method may comprise predefining for each data item a probability matrix to associate the data item with a set of attribute values.

The query method may comprise using the probabilities to resolve ambiguities in the query.

The query method may comprise a stage of processing input text comprising a plurality of terms relating to a predetermined set of concepts, to classify the terms in respect of the concepts, the stage comprising

arranging the predetermined set of concepts into a concept hierarchy,

matching the terms to respective concepts, and

applying further concepts hierarchically related to the matched concepts, to the respective terms.

Preferably, the concept hierarchy comprises at least one of the following relationships

(a) a hypernym-hyponym relationship,

(b) a part-whole relationship,

(c) an attribute value dimension—attribute value relation,

(d) an inter-relationship between neighboring conceptual sub-hierarchies.

Preferably, the classifying the terms further comprises applying confidence levels to rank the matched concepts according to types of decisions made to match respective concepts.

The query method may comprise:

identifying prepositions within the text,

using relationships of the prepositions to the terms to identify a term as a focal term, and

setting concepts matched to the focal term as focal concepts.

Preferably, the arranging the concepts comprises grouping synonymous concepts together.

Preferably, the grouping of synonymous concepts comprises grouping of concept terms being morphological variations of each other.

Preferably, at least one of the terms has a plurality of meanings, the method comprising a disambiguation stage of discriminating between the plurality of meanings to select a most likely meaning.

Preferably, the disambiguation stage comprises comparing at least one of attribute values, attribute dimensions, brand associations and model associations between the input text and respective concepts of the plurality of meanings.

Preferably, the comparing comprises determining statistical probabilities.

Preferably, the disambiguation stage comprises identifying a first meaning of the plurality of meanings as being hierarchically related to another of the terms in the text, and selecting the first meaning as the most likely meaning.

The query method may comprise retaining at least two of the plurality of meanings.

The query method may comprise applying probability levels to each of the retained meanings, thereby to determine a most probable meaning.

The query method may comprise finding alternative spellings for at least one of the terms, and applying each alternative spelling as an alternative meaning.

The query method may comprise using respective concept relationships to determine a most likely one of the alternative spellings.

Preferably, the input text is an item to be added to a database.

Preferably, the input text is a query for searching a database.

According to a fifth aspect of the present invention there is provided a query method for searching stored data items, the method comprising:

receiving a query comprising at least a first search term from a user,

expanding the query by adding to the query, terms related to the at least first search term,

analyzing the query for ambiguity,

formulating at least one ambiguity-resolving prompt for the user, such that an answer to the prompt resolves the ambiguity,

modifying the query in view of an answer received to the ambiguity resolving prompt,

retrieving data items corresponding to the modified query,

formulating results-restricting prompts for the user,

selecting at least one of the results-restricting prompts to ask the user, and receiving a response thereto

using the received response to exclude ones of the retrieved items, thereby to provide to the user a subset of the retrieved data items as a query result.

Preferably, the query comprises a plurality of terms, and the expanding the query further comprises analyzing the terms to determine a grammatical interrelationship between ones of the terms.

Preferably, the expanding comprises a three-stage process of separately adding to the query:

a) items which are closely related to the search term,

b) items which are related to the search term to a lesser degree and

c) an alternative interpretation due to any ambiguity inherent in the search term.

The query method may comprise at least one additional focusing process of repeating stages iii) to vi), thereby to provide refined subsets of the retrieved data items as the query result.

The query method may comprise ordering the formulated prompts according to an entropy weighting based on probability values and asking ones of the prompt having more extreme entropy weightings.

The query method may comprise recalculating the probability values and consequently the entropy weightings following receiving of a response to an earlier prompt.

The query method may comprise using a dynamic answer set for each prompt, the dynamic answer set comprising answers associated with attribute values, the attribute values being true for some received items and false for other received items, thereby to discriminate between the retrieved items.

The query method may comprise ranking respective answers within the dynamic answer set according to a respective power to discriminate between the retrieved items.

The query method may comprise modifying the probability values according to user search behavior.

Preferably, the user search behavior comprises past behavior of a current user.

Additionally or alternatively, the user search behavior comprises past behavior aggregated over a group of users.

Preferably, the modifying comprises using the user search behavior to obtain a priori selection probabilities of respective data items, and modifying the weightings to reflect the probabilities.

Preferably, the entropy weighting is associated with at least one of a group comprising the items, classifications and classification values of respective attributes.

The query method may comprise semantically parsing the stored data items prior to the receiving a query.

Preferably, the semantic analysis prior to querying comprises pre-arranging the data items into classes, each class having assigned attribute values, the pre-arranging comprising parsing the data item to identify therefrom a data item class and if present, attribute values of the class.

The query method may comprise arranging the attribute values into classes.

Preferably, the classes are pre-selected for intrinsic meaning to subject matter of a respective database.

Preferably, major ones of the classes are arranged hierarchically.

Preferably, the attribute classes are arranged hierarchically.

The query method may comprise determining semantic meaning to a term in the data item from a hierarchical arrangement of the term.

Preferably, the classes are also used in analyzing the query.

Preferably, attribute values are assigned weightings according to the subject-matter of a respective database.

Preferably, at least one of the attribute values and the classes are assigned roles in accordance with the subject matter of a respective database.

Preferably, the roles are additionally used in parsing the query.

The query method may comprise assigning importance weightings in accordance with the assigned roles in accordance with the subject-matter.

The query method may comprise using the importance weightings to discriminate between partially satisfied queries.

Preferably, the analyzing comprises noun phrase type parsing.

Preferably, the analyzing comprises using linguistic techniques supported by a knowledge base related to the subject-matter of the stored data items.

Preferably, the analyzing comprises statistical classification techniques.

Preferably, the analyzing comprises using a combination of:

i) a linguistic technique supported by a knowledge base related to the subject-matter of the stored data items, and

ii) a statistical technique.

Preferably, the statistical technique is carried out on a data item following the linguistic technique.

Preferably, the linguistic technique comprises at least one of:

segmentation,

tokenization,

lemmatization,

tagging,

part of speech tagging, and

at least partial named entity recognition of the data item.

The query method may comprise using at least one of probabilities, and probabilities arranged into weightings, to discriminate between different results from the respective techniques.

The query method may comprise modifying the weightings according to user search behavior.

Preferably, the user search behavior comprises past behavior of a current user.

Preferably, the user search behavior comprises past behavior aggregated over a group of users.

Preferably, an output of the linguistic technique is used as an input to the at least one statistical technique.

Preferably, the at least one statistical technique is used within the linguistic technique.

The query method may comprise using two statistical techniques.

The query method may comprise assigning of at least one code indicative of a meaning associated with at least one of the stored data items, the assignment being to terms likely to be found in queries intended for the at least one stored data item.

Preferably, the meaning associated with at least one of the stored data items is at least one of the item, a classification of the item and classification value of the item.

The query method may comprise expanding a range of the terms likely to be found in queries by assigning a new term to the at least one code.

The query method may comprise providing groupings of class terms and groupings of attribute value terms.

Preferably, if the analyzing identifies an ambiguity, then carrying out a stage of testing the query for semantic validity for each meaning within the ambiguity, and for each meaning found to be semantically valid, presenting the user with a prompt to resolve the validity.

Preferably, if the analyzing identifies an ambiguity, then carrying out a stage of testing the query for semantic validity to each meaning within the ambiguity, and for each meaning found to be semantically valid then retrieving data items in accordance therewith and discriminating between the meanings based on corresponding data item retrievals.

Preferably, if the analyzing identifies an ambiguity, then carrying out a stage of testing the query for semantic validity to each meaning within the ambiguity, and for each meaning found to be semantically valid, using a knowledge base associated with the subject-matter of the stored data items to discriminate between the semantically valid meanings.

The query method may comprise predefining for each data item a probability matrix to associate the data item with a set of attribute values.

The query method may comprise using the probabilities to resolve ambiguities in the query.

According to a sixth aspect of the present invention there is provided a query method for searching stored data items, the method comprising:

receiving a query comprising at least two search terms from a user,

analyzing the query by determining a semantic relationship between the search terms thereby to distinguish between terms defining an item and terms defining an attribute value thereof,

retrieving data items corresponding to at least one of identified items,

using attribute values applied to the retrieved data items to formulate prompts for the user,

asking the user at least one of the formulated prompts and receiving a response thereto

using the received response to compare to values of the attributes to exclude ones of the retrieved items, thereby to provide to the user a subset of the retrieved data items as a query result.

Preferably, the analyzing the query comprises applying confidence levels to rank the terms according to types of decisions made to reach the terms.

According to a seventh aspect of the present invention there is provided a query method for searching stored data items, the method comprising:

receiving a query comprising at least a first search term from a user,

parsing the query to detect noun phrases,

retrieving data items corresponding to the parsed query,

formulating results-restricting prompts for the user,

selecting at least one of the results-restricting prompts to ask a user, and receiving a response thereto

using the received response to exclude ones of the retrieved items, thereby to provide to the user a subset of the retrieved data items as a query result.

Preferably, the parsing comprises identifying:

i) references to stored data items in the query, and

ii) references to at least one of attribute classes and attribute values associated therewith.

The query method may comprise assigning importance weights to respective attribute values, the importance weights being usable to gauge a level of correspondence with data items in the retrieving.

The query method may comprise ranking the results-restricting prompts and only asking the user highest ranked ones of the prompts.

Preferably, the ranking is in accordance with an ability of a respective prompt to modify a total of the retrieved items.

Preferably, the ranking is in accordance with weightings applied to attribute values to which respective prompts relate.

Preferably, the ranking is in accordance with experience gathered in earlier operations of the method.

Preferably, the experience is at least one of a group comprising experience over all users, experience over a group of selected users, experience from a grouping of similar queries, and experience gathered from a current user.

Preferably, the formulating comprises framing a prompt in accordance with a level of effectiveness in modifying a total of the retrieved items.

Preferably, the formulating comprises weighting attribute values associated with data items of the query and framing a prompt to relate to highest ones of the weighted attribute values.

Preferably, the formulating comprises framing prompts in accordance with experience gathered in earlier operations of the method.

Preferably, the formulating comprises including a set of at least two answers based on the retrieved results, each answer mapping to at least one retrieved result.

According to an eighth aspect of the present invention there is provided an automatic method of classifying stored data relating to a set of objects for a data retrieval system, the method comprising:

defining at least two object classes,

assigning to each class at least one attribute value,

for each attribute value assigned to each class assigning an importance weighting,

assigning objects in the set to at least one class, and

assigning to the object, an attribute value for at least one attribute of the class.

Preferably, the objects are represented by textual data and wherein the assigning of objects and assigning of the attribute values comprise using a linguistic algorithm and a knowledge base.

Preferably, the objects are represented by textual data and the assigning of objects and assigning of the attribute values comprise using a combination of a linguistic algorithm, a knowledge base and a statistical algorithm.

Preferably, the objects are represented by textual data and wherein the assigning of objects and assigning of the attribute values comprise using supervised clustering techniques.

Preferably, the supervised clustering comprises initially assigning using a linguistic algorithm and a knowledge base and subsequently adding statistical techniques.

The query method may comprise providing an object taxonomy within at least one class.

The query method may comprise providing an attribute value taxonomy within at least one attribute.

The query method may comprise grouping query terms having a similar meaning in respect of the object classes under a single label.

The query method may comprise grouping attribute values to form a taxonomy.

Preferably, the taxonomy is global to a plurality of object classes.

Preferably, the objects are represented by textual descriptions comprising a plurality of terms relating to a predetermined set of concepts, the method comprising a stage of analyzing the textual descriptions, to classify the terms in respect of the concepts, the stage comprising

arranging the predetermined set of concepts into a concept hierarchy,

matching the terms to respective concepts, and

applying further concepts hierarchically related to the matched concepts, to the respective terms.

Preferably, the concept hierarchy comprises at least one of the following relationships

(a) a hypernym-hyponym relationship,

(b) a part-whole relationship,

(c) an attribute dimension—attribute value relation,

(d) an inter-relationship between neighboring conceptual sub-hierarchies.

Preferably, classifying the terms further comprises applying confidence levels to rank the matched concepts according to types of decisions made to match respective concepts.

The query method may comprise:

identifying prepositions,

using relationships of the prepositions to the terms to identify a term as a focal term, and

setting concepts matched to the focal term as focal concepts.

Preferably, the arranging the concepts comprises grouping synonymous concepts together.

Preferably, the grouping of synonymous concepts comprises grouping of concept terms being morphological variations of each other.

Preferably, at least one of the terms has a plurality of meanings, the method comprising a disambiguation stage of discriminating between the plurality of meanings to select a most likely meaning.

Preferably, the disambiguation stage comprises comparing at least one of attribute values, attribute dimensions, brand associations and model associations between the terms and respective concepts of the plurality of meanings.

Preferably, the comparing comprises determining statistical probabilities.

Preferably, the disambiguation stage comprises identifying a first meaning of the plurality of meanings as being hierarchically related to another of the terms, and selecting the first meaning as the most likely meaning.

The query method may comprise retaining at least two of the plurality of meanings.

The query method may comprise applying probability levels to each of the retained meanings, thereby to determine a most probable meaning.

The query method may comprise finding alternative spellings for at least one of the terms, and applying each alternative spelling as an alternative meaning.

The query method may comprise using respective concept relationships to determine a most likely one of the alternative spellings.

According to a ninth aspect of the present invention there is provided a method of processing input text comprising a plurality of terms relating to a predetermined set of concepts, to classify the terms in respect of the concepts, the method comprising

arranging the predetermined set of concepts into a concept hierarchy,

matching the terms to respective concepts, and

applying further concepts hierarchically related to the matched concepts, to the respective terms.

Preferably, the concept hierarchy comprises at least one of the following relationships

(a) a hypernym-hyponym relationship,

(b) a part-whole relationship,

(c) an attribute dimension—attribute value relation,

(d) an inter-relationship between neighboring conceptual sub-hierarchies.

Preferably, the classifying the terms further comprises applying confidence levels to rank the matched concepts according to types of decisions made to match respective concepts.

The query method may comprise

identifying prepositions within the text,

using relationships of the prepositions to the terms to identify a term as a focal term, and

setting concepts matched to the focal term as focal concepts.

Preferably, the arranging the concepts comprises grouping synonymous concepts together.

Preferably, the grouping of synonymous concepts comprises grouping of concept terms being morphological variations of each other.

Preferably, at least one of the terms comprises a plurality of meanings, the method comprising a disambiguation stage of discriminating between the plurality of meanings to select a most likely meaning.

Preferably, the disambiguation stage comprises comparing at least one of attribute values, attribute dimensions, brand associations and model associations between the input text and respective concepts of the plurality of meanings.

Preferably, the comparing comprises determining statistical probabilities.

Preferably, the disambiguation stage comprises identifying a first meaning of the plurality of meanings as being hierarchically related to another of the terms in the text, and selecting the first meaning as the most likely meaning.

The query method may comprise retaining at least two of the plurality of meanings.

The query method may comprise applying probability levels to each of the retained meanings, thereby to determine a most probable meaning.

The query method may comprise finding alternative spellings for at least one of the terms, and applying each alternative spelling as an alternative meaning.

The query method may comprise using respective concept relationships to determine a most likely one of the alternative spellings.

Preferably, the input text is an item to be added to a database, or is a query for searching a database. That is to say the methodology of the present invention is applicable to both the back end and the front end of a search engine where the back end is a unit that processes database information for future searches and the front end processes current queries.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram showing a search engine according to a first embodiment of the present invention in association with a data store to be searched;

FIG. 2 is a simplified block diagram showing the search engine of FIG. 1 in greater detail;

FIG. 3 is a simplified flow chart showing a process for indexing data according to a preferred embodiment of the present invention; and

FIG. 4 is a simplified diagram showing in greater detail the process of FIG. 3.

### DESCRIPTION OF THE PREFERRED EMBODIMENTS

The present embodiments provide an enhanced capability search engine for processing user queries relating to a store of data. The search engine consists of a front end for processing user queries, a back end for processing the data in the store to enhance its searchability and a learning unit to improve the way in which search queries are dealt with based on accumulated experience of user behavior. It is noted that whilst the embodiments discussed concentrate on data items which include linguistic descriptions, the invention is in no way so limited and the search engine may be used for any kind of item that can itself be arranged in a hierarchy, including a flat hierarchy, or be classified into attributes or values that can be arranged in a hierarchy. The search may for example include music.

The front end of the search engine uses general and specific knowledge of the data to widen the scope of the query, carries out a matching operation, and then uses specific knowledge of the data to order and exclude matches. The specific knowledge of the data can be used in a focusing stage of querying the user in order to narrow the search to a scope which is generally of interest to the user. In addition it is able to ask users questions, in the form of prompts, whose answers can be used to further order and exclude matches. It will be appreciated that prompts may be in forms other than verbal questions.

The back end part of the search engine is able to process the data in the data store to group data objects into classes and to assign attributes to the classes and values to the attributes for individual objects within the class. Weightings may then be assigned to the attributes. Having organized the data in this manner the front end is then able to identify the classes, and attributes, and the objects and attribute values from a respective user query and use the weightings to make and order matches between the query and the objects in the database. Questions may then be asked to the user about objects and attributes so that the set of retrieved objects can be reduced (or reordered). The questions relating to the various attributes may then be ordered according to the attribute weightings so that only the most important questions are asked to the user.

Both the front end when parsing textual queries, and the back end when parsing textual data items, may use either linguistic or statistical NLP techniques or a combination, in order to parse the text and derive class and attribute information. A preferred embodiment uses shallow parsing and then two statistical classifiers and one linguistically motivated rule-based classifier. Preferred embodiments use supervised statistical classification techniques.

The learning unit preferably follows query behavior and modifies the stored weightings to reflect actual user behavior.

The principles and operation of a search engine according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

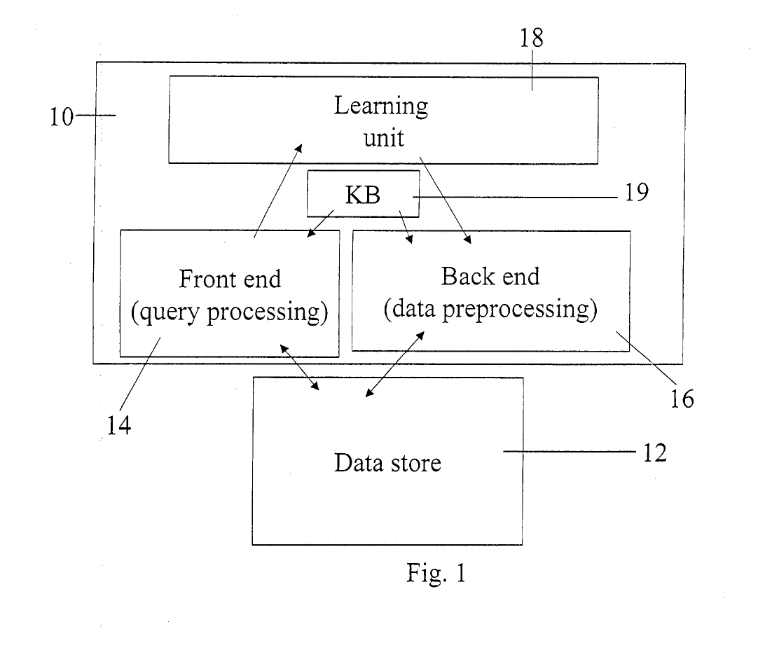

Reference is now made to FIG. 1, which is a simplified block diagram illustrating a search engine according to a preferred embodiment of the present invention. Search engine 10 is associated with a data store 12, which may be a local database, a company's product catalog, a company's knowledge base, all data on a given intranet or in principle even such an undefined database as the World Wide Web. In general the embodiments described herein work best on a defined data store of some kind in which possibly unlimited numbers of data objects map onto a limited number of item classes.

The search engine 10 comprises a front end 14 whose task it is to interpret user queries, broaden the search space, search the data store 12 for matching items, and then use any one of a number of techniques to order the results and exclude matched items from the results so that only a very targeted list is finally presented to the user. Operation of the front end unit will be described in greater detail hereinbelow.

Back end unit 16 is associated with the front end unit 14 and with the data store 12, and operates on data items within the data store 12 in order to classify them for effective processing at the front end unit 14. The back end unit preferably classifies data items into classes. Usually, multiple-classifications are provided for every data-item and are stored as meta-data annotations. Each classification is supplied with a confidence weight. The confidence weight preferably represents the system's confidence that a given class-value truly applies to the item.

The classification processes carried out by the back-end unit, and the query analysis processes carried out by the front-end unit, make use of the data stored in a knowledge base 19.

The learning unit 18 preferably follows actual user behavior in received queries and modifies various aspects of knowledge stored in the knowledge base 19. The learning may range from simple accumulation of frequency data to complex machine learning tasks

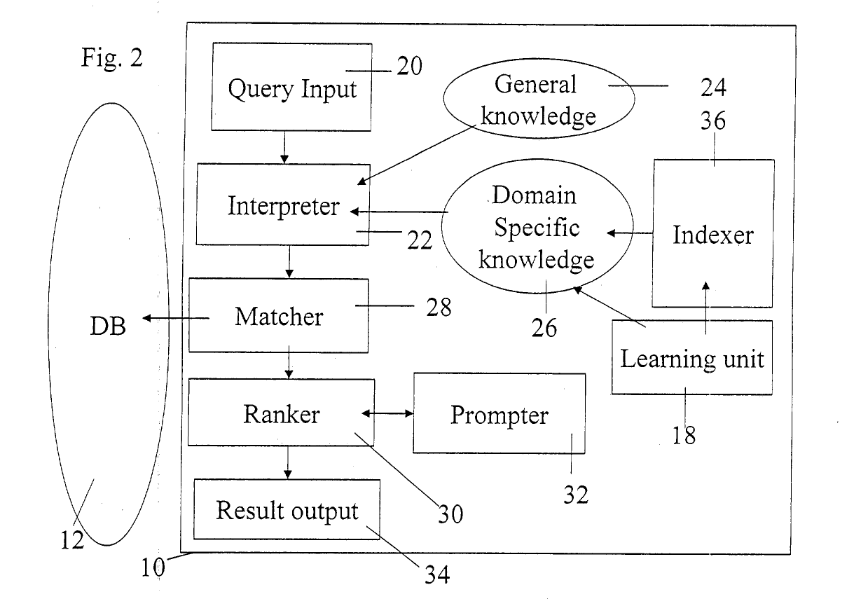

Reference is now made to FIG. 2, which is a simplified diagram illustrating in greater detail the search engine 10 of FIG. 1.

A query input unit 20 receives queries from a user. The queries may be at any level of detail, often depending on how much the user knows about what he is querying. An interpreter 22 is connected to the input and receives the query for an initial analysis. The interpreter analyzes, interprets and enhances the request and reformulates it as a formal request. A formal request is a request that conforms to a model description of the database items. A formal request is able to provide measures of confidence for possible variant readings of that request. In order to make up the formal request and also in order to provide for variants, the interpreter 22 makes use of a general knowledge base 24, which includes dictionaries and thesauri on one hand, and domain-specific semantic data 26 garnered from items in the data store. The domain specific data may be enhanced using machine learning unit 18, from the behaviors of previous users who have submitted similar queries, as noted above. In addition, the interpreter parses the request as a series of nouns and adjectives, and attempts to determine which terms in the query refer to which known classes (in the classification scheme), taking into account that some class-values are considered as attributes for other class-values. Thus, in the query “red long-sleeved shirt”, the term “shirt” would be interpreted as referring to the class “shirts”, “red” would be interpreted as a value for the attribute class “color” as defined for shirts, and “long-sleeved” would be interpreted as a value for the attribute class “sleeve length” as defined for the class of shirts. With the above interpretation, the search process would therefore concentrate on the class of shirts and look for an individual shirt which is red and has long sleeves.

A matchmaker 28 then has the task of searching the data store (possibly making use of various indices), which may include one or more separate databases, to find the items that match components of the formal request. A ranker 30 provides a numerical value to describe the overall level of match between the query and each data item, i.e. it assesses the relevance of data-items to the query. This relevance rank is affected by the quality of match of components of the formal request, the confidence in variant readings of the query, and the confidence measures of data classification (if available) attached to the items by the Indexer.

The numerical value can then be thresholded to decide whether to add the data item to a result space or not. Also the retrieved data items within the results space can be ordered in decreasing relevancy according to the scores computed by the ranker. Thus, in the above example, item “plain red cotton shirt with long sleeves” would be added to the results space with a high degree of confidence, as would “plain red nylon shirt with long sleeves”. An item “patterned cotton shirt with long sleeves” might be added to the results with a lower degree of confidence and an item “plain tee-shirt with collar” with an even lower degree of confidence.

Scoring by the ranker is supported by prompter 32 which conducts a clarification dialog with the user, as needed. That is to say the prompter presents the user with the possibility of specifying additional information that can be used to modify and compact the results space.

We believe it is useful to distinguish between two type of prompts. One type is disambiguation prompts, designated to clear up ambiguities in query interpretation, usually when a query takes a textual form. For example, if the query interpretation process encounters an ambiguous term in the query, the system may generate a prompt requesting indication as to which sense of the term was intended. Another example—if the query interpretation process discovers a spelling error in the query, the system may generate a prompt requesting indication as to which spelling correction should be used. Another type of prompt is the reduction prompt, which is directly designated to obtain information that can be used to modify and compact the results space, with no relation to ambiguities that might appear in the query. As an example of a reduction prompt, in the above case the prompter could ask the user if (s)he prefers patterned or plain shirts or has no preference and whether or not (s)he is interested in regular shirts, sweat-shirts or tee-shirts.

Prompting with each kind of prompt may be carried out before or after item retrieval from the database. It will be appreciated that prompting following item retrieval is preferably only carried out to the extent that it effectively discriminates between items. Thus a question such as “do you want a regular shirt or a tee-shirt?” will not be asked unless the current results space includes both types of shirt. Generally, prompting that is aimed to modify and compact the results space, is conducted after item retrieval, since the composition of the prompt depends on the outcomes of the retrieval. However, canned prompts may be used even before item retrieval, triggered merely by interpretation of the query.

The prompter 32 generates possible prompts. Prompts may take the form of specific questions, or an array of choices, or a combination of these and other means of eliciting user responses. The prompter includes a feature for evaluating each particular prompt's suitability for refining the set of results, and selects a short list of most useful prompts for presentation to the user. The prompts may be submitted with a representative section of the ranked list of items or item headers/descriptors, if felt to be appropriate at this stage.

Usually, reduction prompts implicitly or explicitly require the user to indicate some classificatory information that might be used to modify and reduce the relevant results set. Thus, the collection of possible reduction prompts is dynamically drawn from a set of classifications that are available or can be made immediately available for the data items in the information storehouse (e.g. the database). Prompts are generated dynamically, depending on query interpretation and on the composition of the current relevant results set. Thus, if the initial query was for shirts, it makes sense to have prompts for color, material, size, sleeve length and price etc, and the relevant prompts may be obtained from the classifications that are directly related to the “shirt” class. The prompter evaluates the available prompts to decide which would make most difference to the results set and which is most likely to be seen as important by the search engine user. Thus if the user has requested red cotton shirts, and all of the red shirts retrieved are long sleeved, it makes no sense to ask the user about sleeve length. If, out of a hundred shirts received, only one is short sleeved, it will make very little difference to the results set to ask about long or short sleeves. The results set will either be reduced by one, or, on the other hand, the user will be deprived of any choice at all. If, on the other hand about half the shirts in the relevant set are long-sleeved and half are short sleeved, then it makes a great deal of sense to ask about sleeve length since, unless a “don't care” answer is received, a significant reduction can be made to the results set.

The set of classifications that are available or can be made immediately available for the data items are defined by the navigation guidelines that were set up for the database. Generally, the guidelines preferably contain a collection of hierarchically structured conceptual taxonomies for domain-specific browsing. Each node in a hierarchy represents a potential class, it may have query terms associated with it and may be linked to a set of domain data items which may be ranked using weighting values. Additional navigation information includes specifications as to which classes are considered as attributes for which other classes, additional relations between concepts, relevance of different attributes, and possible attribute values, as will be explained in greater detail below.

When the ranker 30 is supplied with a response to a prompt, the response is evaluated and the formal request may be updated with additional restricting specifications, The ranker reassigns relevance ranks to each item, and possibly modifies and compacts the relevant set of results. The new ranked list is examined again for possible prompts and the whole cycle is repeated until the user signals that a satisfactory set of results has been achieved or the system decides that no further refinements can or should be done. At any stage of the cycle, the set of achieved results can be output to the user via output 34, in any appropriate form (as text, images, links, etc.).

The responsibility of the learning unit 18 is to enhance overall search engine performance during the course of use, using machine learning techniques. The data for use in the learning process is accumulated by collecting users' responses and tracking correlations berween features and between objects and features. The outputs of the learning processes are implemented as modifications in the tables used by other components of the system, such as the ranker 30, the interpreter 22 and the prompter 32.

The learning process is supported by, and involves modification of data in two relatively static infrastructures, prepared off-line: the domain specific knowledge base 26, and an indexer 36, whose operation is discussed below.

As described above, the present embodiments approach query interpretation in a two-stage approach. The first stage interprets each query and generates a formal request for retrieval of items from the data storage in as broad terms as possible so as to assure good recall and good coverage. In a second stage, an interactive cycle of prompts and responses is used to re-rank and further refine the working set of results to ensure good precision.

The process of data retrieval is triggered by an initial request from the user. The process begins with the first of the two stages set out above, namely by enhancing and extending the request to cover items that are closely related to the query, as well as those that pertain to competing interpretations of an ambiguous query. Ambiguities in the query can have origins which are lexical, syntactical, semantic or even due to alternate spelling corrections. Ambiguity may also be due to data store items that are potentially related to the request but to a lesser degree.

In one embodiment, all possible meanings in an ambiguous query are admitted at this first stage. In other embodiments a decision is made to prefer certain of the meanings. In yet other embodiments a prompt is sent to the user asking him to resolve the ambiguity. In a particularly preferred embodiment, different ones of the above-three strategies are applied in different cases. For example a certain ambiguity may be resolved by a simple grammar check to reveal that a spelling emendation leads to a correct grammatical construction. The emended query, that is the version with the correct grammatical construction is then preferred. Semantic processing can be used to determine a context within which a preferred meaning can be selected.

Following resolution of ambiguities in the query, the resulting formal request is used to search the database. Ranked results, or their summaries, are returned to the user, along with questions and/or other prompts that have been tailored to the current group of ranked results and to the expected responses of users. The user's response to these prompts is then used to refine, re-rank and further refine the set of results. Refining continues until the user signals that the results are satisfactory. In an alternative embodiment, the user is initially only sent queries, and the refining process continues until the search engine 10 is satisfied that it has pared down the results to a useful number or until some other criterion for finalizing the results is satisfied.

It will be clear to the skilled person that in many instances the initial query can be unambiguously analyzed to retrieve only a small set of items. In such a case the small set of relevant items can be displayed without it being necessary to engage in the dialogue process just described. The use of a two-stage process of expansion of the query followed by contraction allows for a liberal interpretation of requests, thereby increasing recall, while at the same time, achieving precision by means of repeated prompting and contraction of the results space. The two-stage process is particularly advantageous in its handling of overly-broad initial requests—so-called “almost empty” requests, which the prompt phase can then transform through interaction with the user into precise requests reflecting the thinking of the user. In fact, a preferred embodiment includes an appropriate set of prompts to process even actually blank or empty queries to elicit what the user has in mind, based on material in the relevant data store. Furthermore the two stages can be adapted between them to support queries made in languages other than that in which the material is stored. That is to say the stage of query interpretation includes the ability to treat foreign words representing the products and their attributes in the same way as any other synonym for those words. Foreign language query interpretation is unavoidably tainted with the inherent ambiguity of translation, however the two-stage process is preferably able to question its way out of this ambiguity in the same way as it deals with any other ambiguity.

In general, requests and/or queries may take many forms, formal or informal, often depending on the level of expertise of the user and the kind of material he is looking for. When a query is textual and is formulated in informal natural language, the initial expansion stage includes a stage of interpretive analysis. The analysis stage is preferably used to convert the informal query to take on a formal request model or format. The query is systematically parsed by a combination of syntactic and semantic methods, with the aid of the general knowledge base 24, which includes data for general-purpose Natural Language Processing. Conceptual knowledge (ontologies and taxonomies) related to the subject domain of the database (datastore) and lexical knowledge (the words, phrases and expressions that are used to express the concepts) are examples of the kinds of data used within the knowledge base and may be stored in the specific knowledge base 26. Additionally, the specific data base 26 comprises statistical data garnered from the items in the data store or the data set. The general and specific knowledge base pair, 24 & 26, is discussed below.

Parsing is used on received textual queries (or queries which where converted to text from any other form, such as voice), so as (1) to detect the presence of words, phrases and expressions (hereafter collectively called ‘lexical terms’) that may signify important concepts in the specific knowledge base and thus refer to important classifications of the data items, (2) detect any other lexical terms, (3) determine the semantic/conceptual relations between the detected lexical terms, possibly utilizing syntactic and semantic analyses. Analysis of the detected important lexical terms includes judgment on whether they signify values for object classes (such as shirt, tv-set, etc.) or attribute classes (such as color, material, price, etc.), whether they have alternative interpretations and whether any interpretations of the terms are supported or undermined by interpretation of other parts of the query (if such are found). The identified values are then used to translate the query into a form of machine readable formal request to conduct the actual search in the database. In addition, the interpretive analysis process assigns confidence ranks to every interpretation.

Taking the example of the data set of an e-commerce portal, the query analysis preferably initially detectso the commodity specified (a shirt, a shoe, a book, etc)—sometimes to a set of potentially competing commodities (e.g. ‘pump’—a kind of shoe or a pumping device)—and to the various attribute-values that may be specified in the query, such as color, material, style, price-range, etc.

For example, successful parsing uses grammar constructions to distinguish between the query “hangers for coats” in which the object pointed to is a hanger, and “waterproof coats” in which the object is a coat and “waterproof” is an attribute.

Turning again to the back end unit 16, in order to facilitate the matching process, items can be pre-indexed, with an index including annotations that specify classification values for data items. In this approach, indexer 36 is used, generally offline, to annotate data items with classification values on various conceptual dimensions (such as objects and attributes)s and/or keywords expressing such classifications, of the kinds that may appear in search requests for the relevant subject domain. In the example of the e-commerce portal referred to above these may be the commodity specification and the product attribute-values. Items can also be enhanced with synonyms, that is to say equivalent terms, including acronyms and abbreviations, hypernyms (which are more general terms), hyponyms (which are more restricted terms), and other potentially relevant search terms. Each classification value assigned to a data item is complemented with a confidence rank, reflecting the system's confidence in that classification and/or expresses the estimated probability of that assignment's correctness.

An offline indexer is not essential, and in the absence of an offline indexer, analysis of items for contexts, classification values and keywords may be carried out online during the matching stage, as will be explained in more detail below.

The strength of a match between the formal request and any data item is determined, among other factors, by the importance assigned to the various components of the query that are successfully matched. Some features are set to be more significant than others—for example, features (values) representing a commodity class are set to be appreciated as being far more important than attribute-values of the product. Thus, in a search for a green coat, greater importance is attached to the term “coat”, which is the commodity, than “green” which is a mere attribute. Whilst a blue coat is a reasonable substitute for a green coat, a green shirt is a far less reasonable substitute for a green coat. The strength of the relation may also be used. Synonyms preferably provide better matches for concepts than hypernyms, and the confidence the system has in the various extracted and analyzed features reflects this level of importance. The confidence level ranks of query interpretations and of data items' classifications are also used to influence the ranking of results. The higher is the system's confidence in a particular interpretation of a query, the higher ranked will be corresponding matching data items. Similarly, the higher the system's confidence in a particular classification of a data item, the higher it is likely to be ranked if that classification value matches the search criteria in a relevant way.

Finally, using learning unit 18, machine-learning techniques can be used to improve performance by learning which classes of items are intended by which lexical terms and which responses are likely for different intended items. The learning unit preferably uses ongoing search results to update the probability matrix described above. Learning data may be generic or personalized as discussed in greater detail below. In the personalized case each user has a personalized probability matrix.

Outline of the Process Flow

Following is a general outline of the overall process flow for processing an input query. As discussed above with respect to FIG. 1 the process of the preferred embodiment comprises operation of both the front end and the back end working together on the data, the back end first classsifying the data into predefined classes using various classification techniques and adding the classificatory information to the searchable index, and the front end processing queries and then searching the indexed data. However, the process can be implemented using only the front end unit or only the back end unit, depending on the actual implementation requirements and context, as will be described hereinbelow. That is to say the Front-End unit 14 and the Back-End unit 16, can be independently applied in certain pertinent applications. Referring now to FIG. 2, the Front-End unit 14 comprises the Interpreter 22, the Matchmaker 28, the Ranker 30 and the Prompter 32 components, whereas the Back-End unit 16 comprises the Indexer 36. The General Knowledge 24 and Domain Specific Knowledge 26 ure used by both the Front-End and the Back-End.

The Front-End component 14 is responsible for analyzing user queries and responses. Specifically the Interpreter component analyzes user queries. The Matchmaker unit then retrieves from the data base (DB) data items that match the interpreted desiderata. Ranking of retrieved items is carried out by the Ranker.

The Back-End component 16 is responsible for pre-classifying database items to connect them to potential query components (since query components are expected to signify classes). The classification process has two main aspects: feature extraction and item keyword enrichment, both of which enhance the ability of the front end to carry out potential future query/item matching. Feature extraction classifies items into a feature hierarchy, for example: along the dimensions of commodity, material, color, etc. Extracted features are of use both in ordinary search environments that use key words and query phrases, and in search environments that are arranged for browsing using pre-defined categories. Keyword enrichment is of value in any search environment.

When the back end is used in conjunction with the Front-End, classificatory features extracted by the back end may be used to form dynamic prompts, and enrichments applied by the back-end lower the burden on the Front-End matching process.

The back-end indexing process can be manual or automated, or a combination thereof. From the Front-End perspective, it makes no difference to the ability to operate, whether the database has been indexed manually or automatically. It will be appreciated that the level of indexing may effect the quality of the results of front end operation however. The Front-End can operate even if data-items have not been pre-classified by a Back-End. Database item analysis not performed by the Back-End may be performed by the Front-End when matching and ranking items.

Following are two kinds of applications using the Front-End only without accompanying use of the Back-End:

1 E-tailing—the structured database. The Front-End unit 14 is used with an on-line client whose database includes already structured item information, which structure includes classificatory features of the items. The item entries may include item name, category, price, manufacturer, model, size, color, material, etc. Such structured information is for example particularly available in retail electronics where consumer electronic items of a similar description have relatively uniformly corresponding features. The Front-End is thus able to match requested features with item-features fairly easily, and then formulate prompts to narrow the results list, finally displaying the results best suited to the user's request. As the information is initially well structured, back-end preprocessing may be expected to increase search effectiveness only marginally.

2 On-the-fly indexing—the unstructured database. As a second example, front-end unit 14 may be used with a completely uncategorized database, that is to say a database of items which have features but which are not uniformly presented. The Front-End starts with those items that match an enhanced query, and then analyzes the retrieved items for relevant features, with which it formulates prompts to narrow the results list.

It is also possible to use the back end unit 16 alone without the front end unit. There follow two situations in which the use of a back-end unit alone may be useful.

1. Browsing tree. Many information sites provide a browsing tree. Items are added to the tree, either manually (often the case), or using canned searches. Leaves of the tree can be based on any combination of object and feature classes (e.g. “women's high-heeled shoes”). Use of the indexer 36 of the Back-End unit 16 can firstly create such a browsing tree, and secondly automate and improve the indexing of new items so that they are placed in the proper place on the browsing tree.

2. Feature-based browsing. Many sites ask the user to identify desired features, and then present database items with those features. The indexer 36 of the back end unit 16 can automate and improve item indexing so that retrieval is more complete and more accurate.

Whilst the front and back end components are independent of each other, it is pointed out that the processes carried out by each are similar and the division of labor between them is flexible. There are significant advantages to synergetic use of both. One advantage of synergy of the front and back end units is enhanced effectiveness of the Learning unit 18. The learning unit 18 learns, inter alia from the user responses, about the relationships that exist between terms used by users in their queries, and the eventually retrieved items. In order to annotate the pertinent database items with such relationship information as may be gleaned in the above manner, the learning unit is best implemented in the complete system. Nevertheless, the learning unit can successfully be incorporated as part of a system comprising the front end unit alone, in which case it records the above-mentioned relationships for use in analysis of subsequent queries.

The Knowledge Base

In order to succeed with 1) the classification of data items and 2) interpretation of queries, a Knowledge Base (KB) is used. In the following, details are given concerning the general structure of this KB and the way it may support the various components of the search engine of the present embodiments. The knowledge base supports both front and back end operation.

As mentioned above, the KB consists of two parts, a general lexical knowledge part 24 and a domain specific knowledge part 26. The general lexical knowledge part 24 is a language-general part, that contains dictionaries with morphological, syntactical and semantic annotations, thesauri for various words-relations, and other sources of like general information. The domain specific part 26 comprises a Lexical-Conceptual Ontology, which is designed to support information analysis in the context of search engines, and in a preferred embodiment may be further tailored with knowledge of the kinds of items in the specific database.

Focusing again on searching for products in an e-commerce environment, a Commodities/Attributes Knowledge Base (CAKB), is one possible realization of a Lexical-Conceptual Ontology scheme, specially tailored as an aid for classification tasks that arise during analysis of textual data in the product search context. Specifically, for the domain of e-commerce, the most important classification tasks are:

a) Correct recognition of commodity terms, e.g. shirt, CD player.

b) Correct recognition of attribute value, that is property or feature, terms, e.g. blue.

c) Recognition of various other terms, which may potentially facilitate or impede the first two kinds of tasks. For example, the word ‘color’ refers to an attribute dimension, but its appearance in text may facilitate the interpretation of an attribute-value term, as in “color: blue”. Recognition of terms representing measurement units, geographical locations, common first names and surnames, etc. can facilitate the process of classification from textual descriptions. As another example: the word ‘imitation’ does not signify any commodity or attribute, but it crucially affects interpretation of the expression ‘imitation diamond’.

For the purpose of carrying out the above classification tasks, the CAKB includes two major components, the Unified Network of Commodities (UNC) and the General Attributes Ontology (GAO), and two supporting components, the Navigation Guidelines (NG) and the Commodity-Attribute Relevance Matrix (CARMA), which will now be briefly described.

The Unified Network of Commodities

The Unified Network of Commodities (UNC) contains lexical as well as conceptual information about commodities. Lexically, the UNC includes a large list of terms (words and multi-word expressions) that are commodity names (mostly nouns and noun phrases), each one marked for its meaning, using for example, without limitation, a unique sense-identifier USID), for example a GUID. Thus terms sharing a single commodity sense such as “coat”, “overcoat”, “trenchcoat”, “windcheater”, “cagoule”, “raincoat”, “sou'wester” may be grouped together and given a single unique sense-identifier.

Two major lexical relations are supported in UNC: synonymy—synonymous terms which are marked as having the same USID, and polysemy—ambiguous terms that have more than one meaning (i.e. may signify different types of commodities), which are marked with multiple USIDs, one for each sense. In this vein, the UNC also contains data that may help disambiguate between various senses of a polysemous commodity term given in context. Thus the term “coat” of the previous example may be ascribed a second sense-identifying number for its appearance in phrases such as “a coat of paint”. Whilst the word “coat” is the same string whether referring to outer clothing or to layers of paint, as far as the search context is concerned, two totally different products are concerned and therefore two different meanings are identified and the possibility of ambiguity between them arises. The correct identity number to apply to “coat” in any given case may be determined from the context. Thus both paint and outer clothing have attributes of color, but only one of them has an attribute of material that is liable to have a value of wool or cotton, and only one of them is liable to have an attribute of “quick-drying”. In order to spot the ambiguity, the processing algorithm requires a sufficiently detailed knowledge base. The ambiguity may then be resolved by either looking for attributes to resolve the ambiguity by comparing the data-available with the knowledge base, or by issuing a suitable prompt to the user.

Conceptually, the UNC ontology supports two relations: hypernymy and meronymy. Commodities in the UNC are arranged in a hierarchical taxonomy structured via an ISA link, e.g., a tee-shirt is a kind of shirt (shirt is a hypernym of tee-shirt), and conversely—one kind of shirt is a tee-shirt. An ISA link is the conceptual counterpart of the expression ‘ . . . is a kind of . . . ’ and is well known to skilled persons in the arts of AI, NLP, Linguistics, etc. Moreover, the UNC also includes meronymic relations, i.e., specification of which object classes are parts or components of which other object classes. Since any commodity may belong to more than one super-ordinate category (e.g., hockey pants are both a kind of pants and a kind of sports gear), technically, the UNC hierarchy of commodities is not a tree but rather a directed acyclic graph—that is a graph in which any node, that is commodity, may have multiple parent nodes, but circular linkage is not permitted.

The basic purpose of the lexical aspect of the UNC is to allow recognition of commodity terms during text analysis. The basic purpose of the conceptual (taxonomic and meronymic) parts of the UNC is to specify conceptual relations, which may, and often do, facilitate the conceptual classification of textual descriptions (of products or of requests for products), and also contribute to disambiguation of ambiguous terms.

The General Attributes Ontology

The General Attributes Ontology (GAO) contains information about attributes of the commodities, in a way that is similar to the UNC. Lexically, the GAO includes a large list of terms that are names of commodity attributes, each one marked for its meaning by a corresponding USID, the unique meaning identifier as described above. As in the UNC, synonymy and polysemy of attribute terms are reflected in the GAO, through the USID mechanism. Thus, from the lexical perspective, the UNC and the GAO are very similar and form complementary parts of an annotated ontology. Moreover, there are cases when a word has a commodity sense and an attribute sense (such as ‘denim’ meaning jeans pants, or meaning the denim fabric that is an attribute of many garments), and such a word would thus have one meaning in the UNC and another in the GAO.

Conceptually, the GAO is a collection of hierarchies. As with the UNC, in the technical sense each hierarchy is a directed acyclic graph. Each attribute dimension, such as color, fabric, etc, is a self-contained taxonomic hierarchy of attribute values. It is noted thata hierarchy may be quite flat in some cases. Such hierarchical taxonomies are also structured via the ISA link (e.g. blue is a kind of color, navy is a kind of blue, and conversely one kind of blue is navy). Attribute dimensions may include attribute values and may also include other attribute domains as sub-domains—for example, the domain of physical materials may include the domain of fabrics.

Different senses of a word may be included in different domains—for example, one sense of ‘gold’ may be included in the domain of colors, implying the gold color. Another sense may be included in the domain of materials, that is gold as a material. On the other hand, the same sense of a word may be included in different domains—for example ‘cotton’ may be included in the domain of fabrics and in the domain of materials, or the database may be structured so that materials include fabrics.

The UNC and the GAO are preferably tightly integrated within the CAKB. For each commodity in the UNC, there is provided a specification detailing attributes and/or attribute values that are relevant to that commodity. Moreover, information in the UNC-GAO preferably includes an indication as to whether a specific commodity is to be analyzed only with respect to a restricted set of values of a relevant attribute.

Furthermore, integration between the hierarchies may allow each attribute term to be traceable to commodities for which it is relevant. Certain attributes, such as price, brand, luxury status, associated theme/character, etc, have very wide applicability and in many cases may be associated with any or all commodities. Such a situation is preferably reflected in the integration between the hierarchies and within the hierarchies. Such taxonomic relations may for example specify that “Darth Vader” is related to “Star Wars” and not to “Harry Potter”, and thus influence interpretation of queries and retrieval of data items.

The purpose of the lexical aspect of GAO is to allow recognition of attribute terms during text analysis. The purpose of the conceptual-taxonomic aspect of the GAO is to specify conceptual relations, which may, and often do, facilitate conceptual classification based on textual descriptions of products. Such textual descriptions may be descriptions of the products themselves, for the purposes of the back end unit, from which attributes and attribute values may be derived, or the textual descriptions may be the user entered queries themselves, namely requests for products having given attributes, in the case of the front end unit. For example, knowing that navy is a kind of blue may facilitate the retrieval of navy colored items to a request for blue items.

The purpose of providing tight integration between commodities and attributes is to facilitate classification processes, firstly by providing for each commodity a restriction on which attributes can be reasonably expected when that commodity is specified, and, secondly, by allowing the disambiguation of polysemous conmmodity and attribute terms. For example, in the context of watches, ‘gold’ probably means a kind of metal, while in the context of t-shirts the word probably means a color. Similarly, in the context of heel height, “pump” probably means a kind of shoe, while in the context of hydraulics it would most likely mean a liquid circulation driving component.

Navigation Guidelines (NG)

The Navigation Guidelines component of the KB provides two functionalities and is therefore preferably composed of two parts: the Search-Navigation Tree (SNT), and the Prompts Repertoire (PR) . . .

The SNT is a component that allows the definition of a navigational scheme for a given database, so as to allow navigation within the database (e.g. an e-commerce catalog) in a manner that is similar to the process of browsing a directory tree. The SNT uses the UNC as a hierarchy of commodities and the GAO as a KB of attributes and attribute values, and makes the resulting structure available as a unified navigation tree, typically a directed acyclic graph, to the search and navigation algorithms. That is to say it allows simultaneous navigation based on commodity and attribute terms and interrelationships between the two. In addition, the SNT allows for flexibility and customization (through edit functions) of these knowledge bases, without actually altering the data in UNC and GAO. Flexibility and customization are needed because the core Lexical-Conceptual Ontology is suited for classification tasks, while search and navigation tasks may require a somewhat different view of the ontology. For example, the SNT allows the introduction of new classes, such as nodes that represent thematic groupings of various commodities; the folding of whole branches into single nodes; and the creation of nodes that combine a specific commodity with specific attribute values as a new kind of entity, etc. Specifically, it allows new thematic nodes to be defined, which may not be actual commodities or attribute values, but rather reflect a specific semantic category, such as “sales”, “auction”, “seasonal gifts” or similar terms. The SNT nodes are built to recognize the relevant category of products that matches the user's requests.

The second part of NG, the Prompts Repertoire (PR) organizes data and definitions that are required for the Prompter component of the search engine Front End. The PR defines the set Reduction Prompts that may be presented to a user to help refine the Relevant Set of retrieved data items during a search session. Generally, the set of Reduction Prompts depends on the classificatory dimensions and values that are available (or that can be made potentially available via on-the-fly indexing) for data items of a given database. The NG allows one to define the actual set of available Reduction Prompts, so as to accommodate the specific needs, preferences and policies of the database managers. For example the NG may define which classificatory dimensions should not be used as prompts, which prompts should be preferred over which other prompts, etc. Each prompt reflects a given classificatory dimension such as commodity type, color, etc. The NG component allows one to specify restrictions on the answer sets for prompts—for example to specify how many different answer-options a prompt may provide, or even which specific values (SNT nodes) are allowed as answer-options for a given prompt. It is noted that each answer-option to a prompt in the Repertoire is mapped to only one SNT node and there are preferably many nodes that are not included in the mapping's range. The nodes not included mainly reflect very specific data, which may be identified when the user asks specifically for them, but are not regularly presented as a possible choice for that particular question. For example, if the initial query is just “shirt” and the search engine decides to prompt the user for the preferred color typically only a small set of basic colors, say red, blue, yellow etc. is presented to the user as answer-options (unless the user interface allows for free-text answers). If the user initially asks for a “bright lavender shirt”, however, it is important to identify that specific color, which has preferably been defined as a node in the SNT, but is not mapped to by any answer to the color question.

Another important aspect of the prompts repertoire is its ability to determine the relative importance of the different prompts in the context of any given query. For example, when the commodity sought by the user is a tee-shirt, a reduction prompt concerning color may be conceived as more important than a brand prompt. However, a brand prompt may be conceived as more important than the color one when the commodity is a television. Relative importance values may be used to impose an order on the prompts, and raw or global importance values may be refined by taking into account the user's preferences in answering questions, and/or the e-store's own preferences on what questions to ask its potential customers.

Finally, for each prompt and potential answer options, the NG may store the actual prompting labels that would be presented to users. The labels may take the form of textual questions (e.g. “Which color you prefer?”), textual tags (e.g. ‘black’, ‘white’, etc.), images, etc.

Commodity-Attribute Relevance Matrix

A preferred embodiment of an e-commerce catalog search engineuses a Commodity-Attribute Relevance Matrix (CARMA). The CARMA is a knowledge structure, preferably in the form of a table or matrix, that contains probabilistic relevance values, each value measuring the likelihood of association of attribute types/dimensions such as color, length, size, etc. or attribute values, such as blue, green, small, etc. and given commodities or classes of commodities. In the general case, a similar matrix may be established to measure associations among class-dimensions, between class-dimensions and class values, and among class-values, for a given database. If the data store items have been annotated with appropriate commodity and attribute classifications, then the table entry for commodity c and attribute a contains two numbers: the percentage of items having this commodity and that attribute out of all the items having commodity c, and out of all items having attribute a.

The data from the CARMA can be used in many ways; one preferred use, for word-sense disambiguation in query analysis, will be illustrated here.

1. Disambiguation of an ambiguous commodity term by a co-occurring attribute value. For example, a query may comprise the term “cotton bra”. In the retail context the term “bra” has two senses, one referring to women's underwear and the other being an automotive accessory, a vehicle front-end cover or extension. However cotton is an attribute value for which the corresponding attribute is Fabric, and in CARMA, a value for fabric of cotton is relevant only for sense 1 of “bra”. The automotive part would generally be expected to take values of plastic or metal.

2. Disambiguation of an ambiguous attribute term by a co-occurring commodity term. For example, in “emerald necklace” where “emerald” is ambiguous (a gemstone or a color), CARMA might specify that the color dimension is not relevant for necklaces, so the gemstone sense is preferred. In the case of “emerald t-shirt”, the color sense would be preferred.

3. Mutual disambiguation of a commodity term and an attribute term: For example, in “gold ring”, “gold” has a commodity sense (a piece of gold) and an attribute (material) sense and “ring” has several commodity senses. However, CARMA may specify that “gold” in the attribute-material sense is highly relevant for “ring” in the jewelry-item sense, so this combination of senses is to be preferred.

4. The Prompts Repertoire can also benefit from the CARMA matrix, as detailed in The Prompter description below.

The Indexer

The Indexer 36 is a general set of processes for automatic annotation of items in the database of interest, deriving, for each item, classifying information that can later be taken into account by various system components, such as the Matchmaker component 28. As mentioned hereinabove, a data item is typically accompanied in the database by a textual description, referred to as free text, and the Indexer's goal is to derive, from the free text, classification of the data item on as many dimensions as required; the classifications usually pertaining to the item's object type and the item's features/attributes. The Indexer algorithms extract such information directly from the free text description and also indirectly by comparing a new item's descriptions with those of previously analyzed and checked items. The indexing process may include translating of the free text into machine-readable annotations that can then be added to an electronic version of the item's records. From a functional perspective, the Indexer 36 comprises a limited-scope, yet useful, text-understanding capability.

In the context of electronic commerce, the items being included in the database are typically a commercial product which is represented by a product record. The product record is a text item, usually written by sales and marketing personnel, and may involve a Product Name (PN), written as a title, and a Product Description (PD), presented as a block of text following the title, in sentence style or as a series of notes in a list. Additional formatted information components, such as one or more pictures, a price, a vendor's name, and a catalogue number, may be also present within the free text. In such a case the Indexer preferably tries to extract, from the free text record, a Commodity Classification (CC) of that product and its attributes, properties and features. The first task is accomplished by the Auto-CC-Indexing (ACCI) Component, and the second one by the General Attribute Algorithm (GAA), both of which are described hereinbelow.

Auto-CC Indexing (ACCI)

Currently, the ACCI process used to classify products into commodity classes involves two approaches for CC extraction or inference: a Text-Analysis Approach (TAA), and a Similarity Approach (SA), in the implementation of which several algorithms are preferably involved. Drawing from text categorization and IR vector-space models, the ACCI process uses both linguistically motivated natural language processing (NLP) approaches and statistical classification methods to achieve its goal. Each approach has its advantages as well as its limitations, and a combination of the two approaches is used in a preferred embodiment in order to successfully cover the widest range of possible cases.

Each of the methods, that is to stay statistical and linguistic, proceeds and reaches its conclusion independently of any other methods being used. When each algorithm has cast its vote or made its classification for a product, an Arbitration Procedure, to be described below, resolves conflicts and assigns the final classification for each product.

The Text-Analysis Approach

The starting point of the Text-Analysis Approach is the following. While manufacturers and suppliers tend to tag products with obscure catalog numbers and reference IDs, people commonly refer to products by using words or phrases that denote the commodity class of the product. Such-words and expressions are also commonly found in textual descriptions of products that are written by sales and marketing personnel for communicating to potential buyers. To put it simply, the word ‘shirt’ will probably appear in the PN or PD of a shirt product.

The Text-Analysis process is intended to robustly identify and extract such identifying terms, and use them to provide a commodity classification for the corresponding product. It should be mentioned that the task is not so simple, since in addition to terms that are CC names of the product, the text may include a host of additional words, other CC names, words with ambiguous meanings, synonymous expressions, etc. Thus, the text analysis feature requires language processing ability, inferential capacity and a rich relevant knowledge base, the CAKB, in order to achieve its goal robustly and efficiently.

The text analysis process preferably initially performs shallow parsing on the text, extracts keywords and matches them to a controlled vocabulary of terms in the CAKB, and then makes some inferences for resolving problematic issues (the process automatically defines and detects problematic cases). It produces not only commodity classifications, but also, for each product, a Product Term List (PTL)—a table of terms that represent the key aspects of a product. The list, once produced, can subsequently be used as a starting point for item indexing.

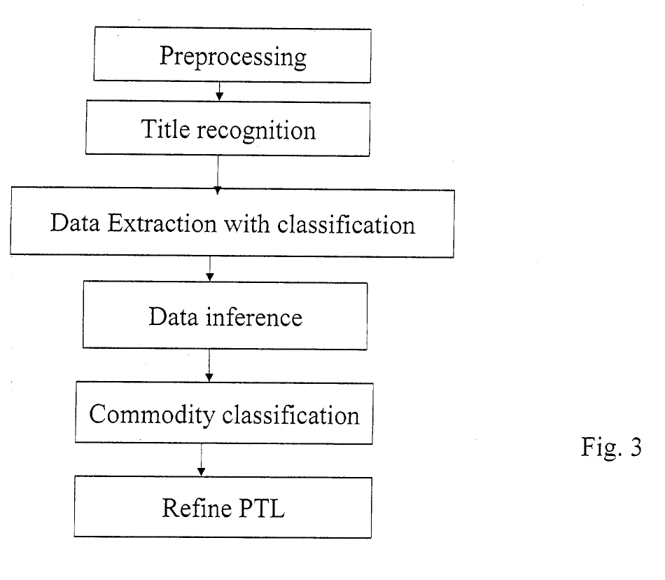

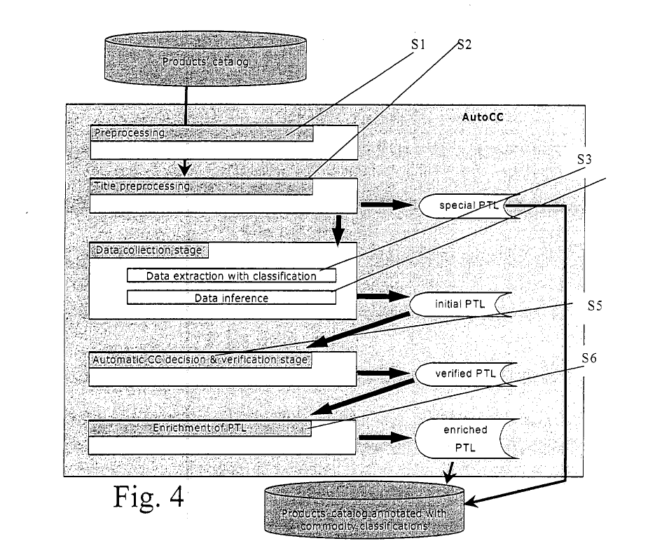

Reference is now made to FIG. 3 and also to FIG. 4, which are simplified flow charts detailing the main steps of the text analysis feature. The process preferably supports carrying out of steps as follows:

1. Preprocessing. Preprocessing of a text includes tokenization, shallow parsing and part-of-speech (POS) analysis of the text.

2. Title recognition. At this stage, an attempt is made to determine, from the free text, as well as from other data available in the database, whether the product is a Content Bearing Entity (CBE—e.g. a book, audio CD, movie, etc.). Such products are processed differently because the terms found in their free text are potentially misleading for classificatory purposes. For example, the words “white shirt” may usually indicate that the products commodity is ‘shirt’ and color is white, but if the product is a book titled “Joe's white shirt”, the classification process has to be different.

3. Data extraction with classification. In a data extraction stage of the text analysis, the system produces an initial PTL for the product, by extracting textual data (keywords and phrases) from both the PN and PD parts of the text, and classifies the extracted textual data into relevant terminology classification groups such as commodity name or attribute. Generally, classification of a term involves finding, for example through CAKB look-up, the general class to which the extracted term belongs. When an extracted term is indeed found in CAKB, important information, such as the general class of the term (its “role”)—whether it is a commodity (CC), a brand name, an attribute name/value, etc—is retrieved from the KB and added to the PTL. In this stage, ambiguities and contradictions are not resolved, they are merely aggregated.

4. Data inference. In a data inference stage, additional data that is not given in the text, may be inferred The inferred data is then added to the PTL. One method of data inference is known as the Brand-Model-Commodity [BMC] affiliation. The BMC describes known affiliations between brands, commodities and models and allows inference of say the product CC (when not explicitly mentioned) if the brand and model name are found in the text.

5. Commodity Classification. A commodity classification stage involves a set of processes that integrate the various data aggregated into the PTL during the data collection stages. The various processes check for inconsistencies, resolve ambiguities, use hierarchical information from a lexical knowledge base (such as UNC) and decide on the final commodity assignment for the product by using supporting evidence from various sources in order to promote the most reasonable assignment. Also, the process automatically computes confidence ranks for the likelihood of a successful classification.

6. Refinement and enrichment of PTL. A refinement stage provides lexical expansion for the refined PTL data (adding synonyms, hyponyms, etc.) and final weights for the PTL entries. The weighted PTL entries can then be used for adding appropriate annotations to the item index records.

The advantage of the approach of FIG. 3 is that it is able to produce effective annotation even under harsh conditions, that is when little is known about the specific database being indexed and when there is no inventory of previously categorized products. A disadvantage of using the approach in such harsh conditions is that, as the skilled person will appreciate upon reading the above, the degree of successful classification depends upon a huge knowledge base that contains a large amount of information about the various areas of the potential subject domains and sub-domains of the kinds of commodities likely to be encountered.

B—The Similarity approach

The similarity approach is radically different from the text analysis approach. The similarity approach is based on the comparison of a new item's textual description with descriptions of previously classified items. The similarity approach is based on the assumption that an item's true commodity class is the same as that of other products previously classified that have the most similar descriptions. The similarity between product descriptions can be computed by well known approaches in IR and statistical classification, namely, by representing items (products) as terms vectors, measuring the similarity of such vectors by the so-called cosine measure or one of its variants. The so-called cosine measure is based on a cosine value which is the number of terms common to two vectors, divided, for normalization purposes, by the product of the lengths of the two vectors.

The skilled person will appreciate that implementing the similarity approach directly can burden the system with a heavy processing load, since the system is then required to compute the cosine of a given vector and cosines for all the perhaps hundreds of thousands available and already classified data items. Thus, in a preferred embodiment the comparison is made between the given vector and a relatively small number of selected and representative data items from the database.

The method of calculating which vectors are in fact most similar to that of the current data item can use any one of numerous criteria. In a preferred embodiment, two algorithms are used in the calculation to implement the Similarity Approach. The algorithms are known as the Clusters algorithm and the Neighbors algorithm.

In the Clusters algorithm, a database of previously categorized products is used to produce clusters of products that belong to the same CC (commodity class). For each CC, the frequency of occurrence of words from texts of all the products included in that CC is tabulated, and a representative vector (a centroid of the CC cluster) is constructed. Classification of a new product involves the comparison of the terms vector of that product with the centroid of each such CC cluster in the IS. The CC of the nearest vector is then assigned to the new product.

Classification using the clusters algorithm approach is relatively fast, since comparisons are carried out with centroids rather than actual product vectors. If each centroid represents ten products then an order of magnitude reduction in the computation complexity is achieved.

The Neighbors algorithm is based on the K Nearest Neighbors (KNN) methodology of statistical classification. In principle, classification of a new product requires, first, the comparison of the terms vector of that product with the terms vectors of each previously categorized product in the IS. Taking the K vectors that are closest to the new product vector, the algorithm assigns to the new product the CC that is associated with the majority of the K most similar products. As a variation, different criteria besides majority can be used in this context.

A preferred embodiment includes advanced differential treatment of the terms occurring in the term vectors. Thus terms that have semantic relevance to candidate products or to product classes, may receive higher weights in the vectors. The semantic relevance may be obtained from the knowledge base. In addition, a preferred embodiment includes methods that reduce the vector space to just the most relevant vectors, so as to avoid the computational overhead that might otherwise be incurred.

The Similarity approach, utilizing the clustering and neighbors algorithms as described above, requires a set of previously categorized products in order to work. Secondly, even with a set of previously categorized products, it may be unsuccessful when handling different commodities or types of commodities from those in the previously categorized set. Thirdly, there is no real guarantee that a similarity of description implies similarity of the commodity class. Nevertheless, in favorable conditions the similarity approach can yield useful results, especially when suitably sophisticated use is made of knowledge base information.

The skilled person will appreciate that different combinations of the various above-mentioned approaches may be optimally selected for different indexing tasks, depending in particular on the extent to which the database is known or understood and the nature or type of knowledge base available.

The Arbitration Procedure

As shown above, classification of a product at least to the level of a Commodity Class, CC, can be achieved using several methods. Each method may provide one or more CCs, preferably accompanied by appropriate confidence ranks, which are its final classification candidates. The Arbitration Procedure's role then, is to resolve classification disagreements between the classification methods, and, in addition, to provide a single final confidence rank for the final assigned classification. Even in a case in which each method provides just one CC candidate and all methods agree on it, the procedure is still required to assign a final confidence rank to the adopted classification.

Let E_{MCC} be the evidence/confidence value (in the 0-1 range) that classification method M attaches to its assignment of a given product into a certain CC; obviously, the CC (or CCs) candidates proposed by M for that product will be those that maximize E_{MCC}. In the case of multiple candidates proposed by M, the ranks may be viewed as a probability distribution, so that it can be assumed in this case that

$${\sum }_{CC} {E}_{CC} = 1.$$

present embodiment each classification method is allowed to provide as necessary a certain number of best candidates. The arbitration procedure then selects the final classification for that product (data item) among all the candidates presented by the various methods used.

Let W_{MCC} be the average past success of M when classifying products into a specific CC. The average past success may be simply the precision rate, or, more adequately, the well-known information-theoretic F-measure:

$$F = \frac{( {β}^{2} + 1 ) \cdot Precision \cdot Recall}{{β}^{2} \cdot ( Precision + Recall )}$$

where β is the importance given to precision relative to recall.

An adjusted confidence rank, for classifying a product into the commodity class CC by classification method M, can be now expressed as CR_{M,CC}=(E_{M,CC}*W_{M,CC}).

When selecting a final classification choice for a given product, the arbitration procedure may implement a number of decision-making voting strategies. A number of such strategies are known to the skilled person and include those known as the Independence strategy, and the Mutual Consistency strategy. Also known to the skilled person are a number of hybrids of the above mentioned strategies.

The Independence strategy assumes that the classification contribution of each classification method is independent of that of the other strategies. The simplest implementation of the independence strategy is to adopt a majority vote: the final CC of the product is the one agreed upon by the majority of methods. A preferred embodiment uses weighted votes so that the vote cast by each method for any of its final candidates is weighted by a set of parameters that reflect the importance attributed to that method and/or its average past success in classifying products. Accordingly, the final (winning) classification is the one that maximizes the sum of all candidate adjusted ranks by all methods M weighted by M importance parameter I, i.e.:

$${TotalCR}_{CC} = [ {\sum }_{M} {CR}_{M , CC} * {I}_{M} ]$$

The value of I may reflect the general past success rate of method M across all classes, e.g. I_{M,}=mean W_{M} (notably, when the total number of classes is large, W_{M,CC} for any specific CC makes only a negligible contribution to the mean W). If all methods are considered equal, I_{M}=1 for every M.

It will be appreciated that weighting for the method (I_{M}) as described above may be additional or alternative to weighting of the selection by the method (W_{M,CC}).

The skilled person will appreciate that more complicated voting strategies along the above lines can be adopted. Moreover, the arbitration procedure may be allowed to choose more than one CC as final classification; for example, it may choose all CCs for which TotalCR_{CC} is above a certain threshold level, and the like.

The Mutual Consistency (MC) strategy is based on the following observation: taking into account the average past success rate of agreement between the members of a partial set of methods provides overall a better estimation of probability for successful classification than considering just the independent success rates of each method.

Considering an MC based strategy in greater detail, suppose three classification methods M₁, M₂, M₃, are used. Method M₁ proposes CC_{I}, and CC_{J}, M₂ proposes CC_{I}, and M₃ proposes CC_{J}. The MC approach checks, using previously aggregated data, the probability of successful classification to class CC_{I}, when this class is agreed upon by methods 1 and 2, and the probability of successful classification to class CC_{J} when methods 1 and 3 are in agreement. The agreement with better success rate is preferred as the final classification.

The past success rate for mutual agreement between members of a subset of the classification methods may be taken, as before, simply as the precision rate, or as an F-measure that takes precision and recall into account. The value of such a parameter can be computed for any specific CC, typically when there is enough data, or as the average across all CC classes, this latter for example when there is not enough data for a specific CC class.

In addition, the MC strategy can also take into account the hierarchical nature of categories (CCs). An agreement between two classification methods may for example be considered not only when both propose the same CC, but also in case the proposed CCs are siblings, that is to say they have the same immediate parent in the hierarchy. The same may be applied to other hierarchical arrangements such as parent and child.

A combination of independent and mutual strategies may be used. A combination of Independence and Mutual Consistency approaches as used in a preferred embodiment is as follows:

For each CC candidate on which there is partial agreement among classification methods, the total confidence rank for that CC, TotalCR_{CC}, is computed as:

$${TotalCR}_{CC} = [ {\sum }_{M} {CR}_{M , CC} * {I}_{M} ] * [ \frac{log {W}_{MA}}{{\sum }_{M ∈ MA} log {W}_{M}} ]$$

where W_{MA} is the success rate of mutual agreement and W_{M} is success rate of a single method M.

The final (winning) classification is the one that maximizes the cumulative rank described above.

The Final Confidence Rank (FCR), assigned by the Arbitration Procedure as a measure of confidence in its decision (and expressed as a probability), takes into account the difference between TCR_{CC} of the winning CC and that of all the other candidates, and is expressed by the following formula:

$${FCR}_{CC ∈ Winners} = \frac{{TCR}_{CC ∈ Winners}}{{\sum }_{CC} {TCR}_{CC}}$$

General Attribute Algorithm (GAA)

The General Attribute Algorithm (GAA) is a generic facility designed to provide attribute classifications for items in a database (DB) or information store (IS). Different kinds of attributes require different kinds of data and different algorithms for successful classification. Classification can efficiently make use of different kinds of information, but its quality remains crucially dependent on the quality and scope of underlying semantic information. For example, if one were aware of only seven out of dozens of color names, it would come as no surprise that the color attribute-indexing has a low coverage. If, furthermore there has been no attempt to identify in advance misleading expressions that mention but do not identify color then attribute indexing may suffer from low accuracy. For example a phrase such as “green with envy” does not in fact indicate the color green. “Snow white” may indicate a pure version of the color white but “pure as the driven snow” has nothing to do with color at all.

Three complementary approaches are used by the GAA for inferring an attribute value from a product textual description: Keywords Extraction, Inference, and Similarity (clustering) Analysis.

Each approach can potentially suggest a certain attribute value, and may allow that value to be accompanied by a confidence rank. In the case of conflicting suggestions, an arbitration procedure of the kind outlined above may be applied. The simplest arbitration procedure is to retain only the value with the highest rank, and to disregard all other proposed values.

The three complementary approaches provided by the GAA are as follows:

A—Keywords Extraction

In the keyword extraction approach, keywords for the possible values of a given attribute dimension are identified and extracted using look-ups in the GAO knowledge base in which all such keywords and their related contextual information are preferably stored. For example, if the word “red” occurs in a product description and is stored in GAO as a color value, then there is reasonable evidence to infer that the product's color is indeed red. We should be aware however of the fact that the occurrence of a specific word in the product's text may not be enough to infer from it an attribute value for that product. Other textual conditions, such as the context in which the keyword appears, must be considered. If a color keyword appears after the phrase “available in colors:”, then the probability of it actually indicating the color value is high, but in the expression “Levi's red label jeans” the probability of the keyword “red” indicating the color “red” is very low. Each attribute-value keyword in the GAO may have associated specifications of supporting, and misleading contexts. Contexts can be defined, for example, using regular expressions. Generally, upon encountering an attribute-value keyword in text of a data item, the GAA analyzes contextual information to determine the credibility of that keyword in its context.

B—Inference

Certain decisions about attribute values can be inferred from other, already available and trustworthy, classificatory information. Various inference tables, such as CARMA discussed above, are included in the CAKB for that purpose.

The most general inference rule available in the GAA has the following format:

“If the product satisfies a given conjunction of conditions Ci then assign each of the possible values V1, . . . , Vn to its classification type T” where C is of the form “Type T has one of the values V1, . . . , Vn”, and Type is a classificatory dimensions (such as commodity, brand, model, color, etc.

Inference rules may also be conditioned by values of confidence ranks of given classifications. When value A is inferred from data B by rule C, then the confidence rank of A will be the product of the confidence rank of B times the confidence rank of C (the probability that rule C is a correct rule). Thus, if gender “woman” is inferred from the CC “skirt”, then the confidence rank of “woman” will be the rank of “skirt” multiplied by the probability that a skirt is indeed for women (which is very high but not absolute, since there may be Scottish skirts for men).

Here are some examples of such rules:

1. Attribute appropriateness: From an identified CC value, infer whether some attribute dimension or even some attribute value is pertinent to the CC being considered. Thus an attribute of length is unlikely to be appropriate for a computer.

2. IS-A inference: Apply all IS-A relations occurring in the CAKB, such as “navy is blue”. Such inferences can also be between different types, such as “from the CC ‘dress’ infer the gender ‘woman’”. Negative inferences (“IS-NOT-A”) are also included under this heading.

3. Disambiguation inference: Previously recorded data can be used to disambiguate among several contradicting values or different interpretations of a given keyword. Thus, having to choose between two different interpretations of “denim” (as a color or as a fabric) we choose the one with the highest pre-recorded confidence rank.

C—Similarity (clustering) Analysis

Similarity or clustering analysis is based on statistical classification algorithms, such as the Support Vectors Machine (SVM). Given an attribute dimension, products are represented by terms vectors, the terms being attribute values in the form of keywords, phrases-in-contexts, or other structural data. Previously categorized products (data items) are clustered by similar attribute values, and clustering centroids are computed. A new product terms vector is then compared, for example using the “cosine” measure or one of its variants, to the different centroids, finally assigning it the attribute value of the closest centroid.

The clustering approach gives satisfactory results for certain attributes, but fails for others. When applied to a clothing database, indexing by clusters achieved more than 90% precision when applied to the gender attribute, but for the fabric attribute, the results were no better that that of a random guess.

A KNN approach for such a comparison is also possible, as was detailed in the previous section for commodity class indexing.

The Interpreter

Given a user request, retrieval of relevant items from the database is achieved by matching the information derived from the query, with the information available for each item in the database. The matching process works best when taking into account the fact that some components of the query such as the name of a commodity, are much more important than other components such as attribute-values.

A number of matching approaches are known to the skilled person. Some matching approaches, such as the Term Frequency/Inverse Document Frequency—TF/IDF may try to infer the relative importance of query components by statistical means. For natural-language queries, however, better results can be achieved by classifying a query's components via syntactic and semantic clues, using at the same time some domain-specific conceptual insights. Thus, one of the major goals of the Interpreter is to detect which parts of the query carry what types of important information.

Applying this idea to the case of electronic commerce, the first goal of the Interpreter is to detect the commodity requested by the user in his query (shirts, digital cameras, flowers, chairs . . . ), whether explicitly stated or just implied. Next, the Interpreter should be able to detect the terms that accurately specify the desired attributes of a commodity, thereby restricting the scope of the items that may satisfy the query. Attributes may be the color and fabric of a garment, the screen size of TVs, etc.

One should note, in this context, that while many attributes can logically apply to only a certain number of commodity classes (e.g. screen size is not a relevant attribute for garments), many others, such as price, luxury-status and brands are applicable to products of almost any commodity. Similarly, a query may consist only of a popular character/theme, whether fictional such as Pokemon, Harry Potter or Jedi, or real, such as Chicago Bulls or The Beatles, without commodity specification. The Interpreter should be able to detect such general kinds of attributes, in the presence of, as well as in the absence of, a commodity specification. In the same vein, it should be able to recognize model names or catalog numbers, such as DCR-PC 115 (a Sony camcorder).

In order to adequately deal with such kinds of information, the Interpreter preferably carries out the following functions:

identify the important terms in the query text,

recognize their conceptual status,

deal with misspellings,

deal with lexical (word-sense) or syntactical ambiguities that are commonly found in natural language,

recognize synonymous or closely-related expressions as pertaining to the same concepts,

detect irrelevant conditions,

be able to sustain multiple reasonable interpretations of an ambiguous query, and

provide a graceful step-down in quality of performance in cases where advanced analysis is not successful.

Some of the means for achieving such abilities are as follows.

A—Query tokenization, including the adequate handling of punctuation marks and of special characters

B—Lemmatization, i.e., reduction of the various query terms to their standard linguistically correct base-form (“lemma”), so as to overcome problems of morphological variants when consulting various external sources, including the CAKB.

C—Misspelling correction. Spelling correction is more complex than it seems, since:

a) many “misspelled‘ strings, especially in the retail world, are just various entity names. For example Kwik-Fit is the name of a car maintenance chain and not a spelling mistake for Quick-Fit;

b) misspellings may occur in the database too, so correcting some misspellings may cause the non-matching of relevant items;

c) there are often many potential corrections that would compete for the intended spelling, and computerized systems may have difficulty in selecting a most appropriate result;

d) consulting a speller for every string while analyzing the suggested corrections for a misspelled one may be a heavy burden on the system resources.

Sophisticated use of an extensive knowledge base is generally able to overcome the above problems and provide for useful spelling correction.

D—Recognition of the conceptual status (“role”) of terms—primarily commodities and attributes—by consulting the conceptually pre-classified CAKB component of the Knowledge Base. Secondary specification, e.g., the kind of attribute to which the term refers may be provided as subclasses of roles—as in Attribute=color, fabric, etc.

Often, important terms are multi-word expressions, and in order to recognize them properly, the algorithm should attempt to locate in the CAKB not only single words, but multi-word sequences as well. This again may place a heavy burden on the system resources, since for a query of n words, any of the subsequences of up to n words might be important terms and thus need to be looked up in the CAKB. However, many insights can be used here to simplify the search, among them, for example, the segmentation of the query into sub-sequences according to punctuation, prepositions and conjunctions and looking for potential multi-word sequences only within the query segments.

E—Distinguishing between focal, that is major, features and supporting or minor features. In a query such as “TV stand” or “a stand for a 50” TV”, the term “TV” should not be recognized as the commodity. The term “TV” is not the focal commodity of the query. Yet, the concept “TV” is not irrelevant, it is important for specifying the type of stand required. Thus, it has a supporting status. In general, the Interpreter is able to detect how the conceptually recognized terms are relevant to the topic of the query. Such detection is achieved by taking into consideration the syntactic and semantic structure of the textual query—specifically, but not limited to, taking into account prepositions and word order in the query. For example, a commodity term that appears after the preposition “for” or “by” is probably not the focal commodity of the query. Such distinctions, encoded during the query analysis, are crucial for satisfactory item matching and ranking.

F—Recognizing synonyms. Synonym recognition is provided, for example, through the above-mentioned USID mechanism, and is thus effective for all synonymous terms present in the CAKB. Any query term recognized in the CAKB preferably returns the appropriate USID, which translates the term into a concept that can be used for all subsequent matching and other processing steps, as the query-term representative. The translation of query terms into concepts means that in effect the data store is searched in terms of concepts rather than by mere keywords.

G—Recognition of misleading or irrelevant data in the query. For example, apparent commodity and attribute terms that appear in a query may be irrelevant if the query, viewed as a whole, refers to an entity name, such as the title (in a general sense) of a book, a CD, a movie, a picture, a poster, a print, etc. For example, in the case where the query is “The Lord of the Rings”, “rings” should not be interpreted as a commodity name. Thus, the Interpreter should be equipped with procedures that allow for the defining and detection of conditions under which the standard analysis is not relevant. In the same vein, misleading attribute-values such as “Rolex-type” for a watch, “faux-fur”, “White Linen”, should be detected and adequately processed. Such procedures are preferably based on an adequate knowledge base.

H—Ambiguity resolution. Natural language is inherently ambiguous. The ability to deal with ambiguities in natural language and to form several different and competing interpretations of a query is preferable for successful performance of a search engine in the face of natural language queries. In the present embodiments ambiguities are dealt with as follows:

Ambiguous terms have multiple entries in the CAKB, each with an appropriate sense identifier. When an ambiguous term appears in the query, all its CAKB-listed meaning-identifiers are returned to the Interpreter. The Interpreter then builds multiple interpretation-versions of the query, using the different senses of query terms. Various methods of word-sense disambiguation may then be used in order to determine which interpretation versions are pure nonsense, which are sensible, and to what degree. Obviously, only the sensible interpretation-versions are retained as final analyses of the query.

The output of the Interpreter with all the interpretation-versions, the roles, the confidence ratings etc, is what has been referred to hereinabove as the Formal Request.

The Matchmaker

The Ranker

The Ranker is responsible for ranking items according to estimated probabilities of matching the user's desiderata (i.e.relevance). The input to the ranking module is composed of the Formal Request and the sequence of user's responses to previous Prompts (if any), along with the database or IS items and any annotations associated therewith.

The ranking phase preferably includes the following stages:

1. Ranking of items retrieved from the database. Some items may be excluded from the ranking, based on a selected threshold of significant mismatch.

2. Building of a Relevant Set. Such a relevant set preferably comprises those items in the IS that are to be taken into account in generating the next Prompt.

3. Building of a Results Set, those items that can or should be displayed to the user. The results set typically comprises items retrieved from the database, retained during the prompting process and exceeding a threshold relevance ranking.

The relevance ranking may takes into account the relative importance of the different components of the Formal Request and prior user's responses (if any). The rank should reflect the likelihood that the ranked item may satisfy the user, by measuring the strength of the match between the request and that particular item. The ranking may factor in the following components:

The likelihood that the formal request reflects the user's desiderata

The likelihood that the analysis of the features and attributes of the item (as extracted by the Indexer) is correct

The (a priori or learned) probability that the attached keywords indeed apply to the specific item

The (estimated or learned) relative importance to users of the role of each component of the request

The probability that a feature assigned to the item may satisfy a user who asks for an item with that feature. A perfect match between these features will return a probability of 1; a less than perfect match, such as when the item commodity is a hypernym of the requested one, preferably reduces the probability accordingly, as discussed above;

The (a priori or learned) probability that the specific item will be requested (also known as popularity measure);

Database (promotional, definitional, etc) biases or constraints;

Cost of retrieval of item. The cost may be to the user or to the system.

The features-rank of each product is a combination of the appropriate numbers from the above detailed list, computed by summing—with appropriate weights—the matching values between the item features and the query features, over all the identified query features. Thus, if a match in color is considered less important than a match in gender, then a gender match weight will be of greater value than a color match one. A final rank assigned to the product is preferably composed of a triplet of equally weighted numbers: commodity rank, attributes (features) rank, and a rank number for other terms. The equal and fixed weight scheme is aimed to ensure that a good match in many analyzed attributes is not for example overcome by a bad commodity match. A user searching for a blue coat made of wool would probably find it acceptable to see woolen coats which are not blue, and maybe blue coats made of a material other than wool, but would probably be rather surprised to see blue woolen sweaters, and the use of separate match figures for commodity and attribute allow for independent insistence on a commodity match irrespective of the attributes.

When several interpretation-versions of the query (denoting several possible interpretations of the user intentions) are returned by the Interpreter, the values of the matches between the item and all the various interpretation-versions are calculated, and the final rank is then a weighted mean (taking into account the various versions' weight) over all versions.

When answers to Prompts are obtained, the item's rank is updated (a posteriori) accordingly.

The purpose of the Relevant Set of items is to improve the Prompter's performance by omitting items with a low probability of satisfying the user, thereby lowering what the user would regard as noise. In a potential realization, only perfect matches are included in the Relevant Set, meaning that each feature, whether commodity feature, attribute feature or other term feature, identified by the Interpreter must provide a significant matching value to the item being considered for retrieval in order to be included in the Relevant Set. If no such perfect match is found, the Relevant Set is enlarged to include less than perfect matches, thus, for example, only a complete failure to find red shirts would prompt the system to consider returning orange shirts.

The Results Set is a certain fraction of the Relevant Set, containing those items with high relevance ranks. These are the items that are to be displayed to the user. The cutoff in both cases may be absolute, relative, or a combination thereof.

The Prompter

The task of the Prompter is to present the user with one or more stimuli, so that the user response to a stimulus can be used to re-rank (and filter) items in the Results Set. The Prompter can be thought of as consisting of two components: the Prompt Generator and the Prompt Chooser. Using the Navigation Guidelines, the Prompt Generator dynamically constructs a set of potential Reduction Prompts based on the relevance-ranked items and their properties. (prompts—Reduction Prompts, are aimed at enriching the information on the specific product requested, for the purpose of narrowing down the potential Relevant Set.)

A Prompt can be visual or spoken, and can take many forms, usually including a prompt clarification data and a series of options for response.

The prompt clarification data can be a question (e.g. “Which brand?”) or an imperative statement (e.g. “Choose color”, or any other method for indicating to the user what kind of information is requested. Parameters and details of prompt clarification data (for example—exact phrasing of questions) are defined and stored in the Navigation Guidelines component discussed above. Prompt clarification data can be used in reduction prompts (as exemplified above) and in Disambiguation Prompts (e.g. “Which meaning you intended?” or “Choose the appropriate spelling correction”). The use of prompt clarification data is not obligatory, as it can be dispensed with when response/answer options are intuitively self-explanatory.

A prompt may allow free-text responses, but usually it provides just a small set of predefined response options. Response options may be presented as:

A menu consisting of a Taxonomy for example U.S.; Europe; Asia . . . ”, an attribute-values list for example “Color: Red; Blue; . . . , or a request for values for aspects such as author; date; merchant . . . , or the prompt may ask for a cost/price range, etc.

A browsing map, such as a navigation map, a semantic network, etc.

Menu choices may be optionally illustrated with pictures, especially with a picture derived from a leading (highly ranked) item related to that choice.

In any given search situation, the prompt chooser may select a large number of prompts based on a given retrieved data set. However, it may not be desirable or even necessary at all to supply all of the prompts to the user. Instead, information-theoretic methods may be applied by the prompt chooser to estimate the utility of the different proposed prompts. As explained above, a prompt for which any answer received is able to make a significant difference to the results set is to be preferred over a prompt for which most answers would merely exclude only a few items. Such an approach can be combined with a cost function for different Prompts, which may be defined in the Navigation Guidelines.

In any given search situation, the main task of the prompt generator is to dynamically choose a list of the most suitable prompts/and answer options. The Prompt Generator checks whether there are any ambiguities in the query interpretation. The disambiguation prompts are constructed from the different interpretations given by the interpreter, and the process does not have to refer to specific items in the relevant set, although the algorithm also considers whether the resolution of such ambiguities would significantly reduce the relevant set of retrieved data items.

As the main course of its action, the prompt generator considers which Reduction Prompts are relevant at the given state of the search session. This is achieved by considering which different classificatory dimensions and values are ‘held’ by data items in the relevant set, and what their frequency distribution in the relevant set is. All answer options presented to the user must have at least one appropriate item to be presented if that answer is indeed chosen. Note that every prompt presented to the user must have, obviously, at least two possible answers for the question to be of any assistance to the search process. Recall that a classificatory dimension (e.g. color, price) defines the prompt, and the values or value ranges (e.g. red, blue; or $50-99, $99-200, etc.) define the answer options. In any given search situation, a potential prompt would be valid only if different data items in the relevant set have at least two different values on the prompt's classificatory dimension. Thus, for example, if the initial query was for shirts, and all the shirts in the relevant set are of the same color, then obviously a prompt “What color?” is not valid. It should be stressed that the class-values on any classificatory dimension may have complex organization (e.g. a hierarchy), the Navigation Guidelines may include specific constraints for Reduction Prompts, and so dynamically computing the relevant Reduction Prompts and answer options is usually quite a complex task.

After building the set of prompts appropriate to the given search situation, the prompts in the set are ranked so as to present the most pertinent prompts to the user. The number of prompts may vary according to circumstances such as the nature of the database and the precision of the initial query, the policy of the user-interface, etc. The rank of a prompt reflects the degree to which an answer to the particular prompt is likely to move the Relevant Set closer to including the data item (e.g. a product) the user is seeking and excluding irrelevant items as much as possible. For this purpose, several computations are preferably made for each data item. One is an entropy calculation that computes an approximation of the expected number of additional prompts needed to identify a satisfactory item after a response to this prompt is received. The entropy calculation preferably provides a ranking value to the respective answer. A correct entropy evaluation will give higher ranks, and a lower entropy value, to prompts with less overlap between items matching each answer. In addition, prompts for which the answers cover more items preferably also get higher ranks and lower entropy. The final rank value applied to a question may then be computed by multiplying the entropy by the question's importance value.

The Learner

As discussed above, machine-learning techniques can be used as an option to enhance search engine performance. Machine learning may be applied in one or more of several areas, particularly including the following:

1. Updating item popularity by tracking user choice of items,

2. Tracking of correlation statistics between specific request terms styles or components and individual items actually selected,

3. Tracking of correlation statistics between attributes, and

4. Improving of prompt choice, by tracking frequency of responses for each item eventually chosen.

For the purpose of enabling machine learning in such circumstances, the following data, amongst others, is preferably collected:

1. Item popularity: How often each item has been chosen,

2. Attribute frequency: How often each attribute value has appeared in a request or in response to a Prompt,

3. Responsiveness: How often each prompt was responded to,—nothing forces a user to answer every question,

4. Attribute-item correlation: For each item, how often the item was chosen after the attribute was requested,

5. Response frequency: For each possible response to a Prompt, how often that response was chosen,

6. Response distribution: For each item, how often it was chosen after receiving a given response

7. Cross-attribute statistics: Correlation matrix between pairs of chosen attribute values

The collected data are used to improve the tables used by the Interpreter, the Ranker, and the Prompter, as appropriate for the given data type. The Interpreter benefits from updated semantic information, for example attribute frequencies and cross-attribute statistics. The Ranker benefits from updated popularity figures, improved annotations, preferably based on attribute-item correlations, and updated response expectations. The Prompter also benefits from the latter.

### CONCLUSION

To summarize the above, aspects of the present embodiments include the following:

1. Overall

a. Preferred embodiments operate on a received query by firstly interpreting the query, then expanding the query to include related terms and items, carrying out matching, and then contracting the result set based on a dialogue with the user in what is known as a focusing cycle. Expansion includes addition of synonyms, and hierarchically and otherwise related terms. Expansion is based on interpretation (query analysis), which may also include carrying out syntactic processing of the query to determine which terms are focus terms (i.e. describe the object required) and which items are descriptive or attribute terms.

b. A preferred embodiment carries out the above operation on a query after the data set has been pre-indexed to organize the items in the data set along with conceptual tags, synonyms, attributes, associations and the like.

2. Front-End-Query Processing

a. Preferred embodiments interpret any given query, especially seeking noun phrases, an approach which is in apposition to “keywords” or “full English” systems such as Ask Jeeves.

b. Interpretation preferably includes parsing of the query into a noun or object being searched for, and attributes, to facilitate search and to assign weights.

3. Front-End facility—the focusing cycle.

a. The Front End may engage in an interactive cycle with a user, aimed at narrowing down the number of possibly relevant data items. In such cycle, the system presents users with prompts, preferably dynamically formulated as questions with response options that the-user can select. Selection of prompts includes considerations of current ‘interview’, past global experience, and specific user preferences. Major consideration is given to how efficiently potential answers may split up the retrieved items. Thus a question having two answers, one of which excludes 98% of the data set, and the other of which excludes the other 2% of the data set, is regarded as a relatively inefficient question. Another question also having two answers, where each answer excludes approximately 50% of the data set, but the excluded parts overlap, would also be regarded as a relatively inefficient question. On the other hand a question having two answers, each of which excludes approximately 50% of the data set and both of which are mutually exclusive, would be regarded as a very efficient question.

In a preferred embodiment, the system may generate several prompts and then use efficiency and other considerations, as described above, to decide which prompts should be presented to the user.

Prompts may be also formed to gain information so as to resolve ambiguities, spelling mistakes and the like, at any stage of the focusing cycle.

b. The Front End uses ranking techniques, both to rank the search results and for selection of prompts. In preferred embodiments, generation of Reduction Prompts is dynamically based on classifications that are available for data items in the infostore ( rather than have preprogrammed, canned questions for given topics).

c. Answer/response options for prompts are dynamically generated. A possible answer is only provided if it maps onto at least one current data item in the relevant set. Preferably, the user is also given the option of not responding to any given prompt, in which case the system may choose to present another prompt. The user can be presented with several prompts at once or the system may wait until receiving the answer for one before asking the next.

d. At any stage of the focusing cycle, the system allows the user to indicate that the current results are not satisfactory. In one embodiment, the user may then be presented with results including those that were initially retrieved but excluded during the the focusing cycle.

4. Back-End—Data Classification and Indexing

a. Indexing preferably involves provision of classificatory annotations to data items in the information store.

b. For purposes of specific embodiments, certain kinds of classes may have privileged status. For example, for the e-commerce catalogs, a distinction is drawn between commodity classes and attribute classes, the latter having certain dependence on the former.

c. Automatic classification preferably uses a combination of rule-based and statistical methods, both using certain linguistic analysis of data items' texts. If different methods are used then arbitration may be used to select the best results.

d.

5. Use of a Learning Unit

A machine-learning unit may be used to gather data from ‘experience’, so as to improve the search processes and/or the classification processes. Learning for improvement of search processes may involve gathering data from user-interaction with the system during search sessions of (users as a whole or any subset of users).6.

Text orientated processing.

Whether processing the query or processing the initial database or processing new items being added to the database, the present embodiments make use of text-oriented methods including the following: linguistic pre-processing—including segmentation, tokenization, and parsing,—handling synonymy and sense identification, handling of inflectional morphology, statistical classification, inferential utilization of semantic information for rule-based classification, probabilistic confidence ranking for linguistic rule-based classification and for statistical classification, combining multiple classification algorithms, combining classification on different facets or items, etc. Handling ambiguity includes dealing with misspellings, lexical/semantic ambiguity and syntactic ambiguity. Generally, ambiguity is handled via an approach known as ‘interpretive versioning’. In interpretive versioning, wherever different interpretations are available, multiple interpretive versions are created. Each version is then submitted to all further stages of the interpretation/classification process, of which some stages involve implicit or explicit disambiguation. Confidence levels and/or likelihood ranks are continuously computed to monitor the plausibility status of the different interpretive versions during the process.

Spelling corrections are dealt with in a context sensitive manner, both for queries and for the data items themselves. In particular, spelling correction suggestions are handled as ambiguities, using contextual information for their resolution.

Overall Conclusion

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An interactive method for searching a database to produce a refined results space, the method comprising:
analyzing for search criteria,
searching said database using said search criteria to obtain an initial result space, and
obtaining user input to restrict said initial results space, thereby to obtain said refined results space.

2. The method of claim 1, wherein said searching comprises browsing.

3. The method of claim 1, wherein said analyzing is performed on said database prior to searching, thereby to optimize said database for said searching.

4. The method of claim 1, wherein said analyzing is performed on a search criterion input by a user.

5. The method of claim 1, wherein said analyzing comprises using linguistic analysis.

6. The method of claim 4, comprising carrying out said analyzing on an initial search criterion to obtain an additional search criterion.

7. The method of claim 6, wherein said search criterion is a null criterion.

8. The method of claim 6, wherein said analyzing for additional search criteria is carried out using linguistic analysis of said initial search criterion.

9. The method of claim 1, wherein said analyzing is carried out by selection of related concepts.

10. The method of claim 1, wherein said analyzing is carried out using data obtained from past operation of said method.

11. The method of claim 1, comprising generating a prompt for said obtaining user input, by generating at least one prompt having at least two answers, said answers being selected to divide said initial results space.

12. The method of claim 11, wherein said generating a prompt comprises generating at least one segmenting prompt having a plurality of potential answers, each answer corresponding to a part of said results space.

13. The method of claim 12, wherein each part of said results space comprises a substantially proportionate share of said results space.

14. The method of claim 12, comprising generating a plurality of segmenting prompts and choosing therefrom a prompt whose answers most evenly divide said results space.

15. The method of claim 11, wherein said restricting said results space comprises rejecting, from said results space, any results not corresponding to an answer given in said user input.

16. The method of claim 15, further comprising allowing a user to insert additional text, said text being usable as part of said user input in said restricting.

17. The method of claim 11, further comprising repeating said obtaining user input by generating at least one further prompt having at least two answers, said answers being selected to divide said refined results space.

18. The method of claim 17, comprising continuing said restricting until said refined results space is contracted to a predetermined size.

19. The method of claim 17, comprising continuing said restricting until no further prompts are found.

20. The method of claim 17, comprising continuing said restricting until a user input is received to stop further restriction and submit the existing results space.

21. The method of claim 17, further comprising determining that a submitted results space does not include a desired item, and following said determination to submit to said user initially retrieved items that have been excluded by said restricting.

22. The method of claim 20, further comprising:
obtaining from a user a determination that a submitted results space does not include a desired item, and
submitting to said user initially retrieved items that have been excluded by said restricting.

23. The method of claim 1, comprising receiving said initial search criterion as user input.

24. The method of claim 11, wherein said obtaining said user input includes providing a possibility for a user not to select an answer to said prompt.

25. The method of claim 24, further comprising asking an additional prompt following non-selection of an answer by said user.

26. The method of claim 1, further comprising updating system internal search-supporting information according to a final selection of an item by a user following a query.

27. The method of claim 26, wherein said updating comprises modifying a correlation between said selected item and said obtained user input.

28. Apparatus for interactively searching a database to produce a refined results space, comprising:
a search criterion analyzer for analyzing to obtain search criteria,
a database searcher, associated with said search criterion analyzer, for searching said database using said search criteria to obtain an initial result space, and
a restrictor, for obtaining user input to restrict said results space, and using said user input to restrict said results space, thereby to formulate a refined results space.

29. The apparatus of claim 28, wherein said search criterion analyzer comprises a database data-items analyzer capable of producing classifications for data items to correspond with analyzed search criteria.

30. The apparatus of claim 28, wherein said search criterion analyzer comprises a database data-items analyzer capable of utilizing classifications for data items to correspond with analyzed search criteria.

31. The apparatus of claim 29, wherein said search criterion analyzer is further capable of utilizing classifications for data items to correspond with analyzed search criteria.

32. The apparatus of claim 29, wherein said database data items analyzer is operable to analyze at least part of said database prior to said search.

33. The apparatus of claim 29, wherein said database data items analyzer is operable to analyze at least part of said database during said search.

34. The apparatus of claim 28, wherein said analyzing comprises linguistic analysis.

35. The apparatus of claim 28, wherein said analyzing comprises statistical analysis.

36. The apparatus of claim 34, wherein said analyzing comprises statistical language-analysis.

37. The apparatus of claim 28, wherein said search criterion analyzer is configured to receive an initial search criterion from a user for said analyzing.

38. The apparatus of claim 37, wherein said initial search criterion is a null criterion.

39. The apparatus of claim 37, wherein said analyzer is configured to carry out linguistic analysis of said initial search criterion.

40. The apparatus of claim 28, wherein said analyzer is configured to carry out an analysis based on selection of related concepts.

41. The apparatus of claim 28, wherein said analyzer is configured to carry out an analysis based on historical knowledge obtained over previous searches.

42. The apparatus of claim 28, wherein said restrictor is operable to generate a prompt for said obtaining user input, said prompt comprising at least two selectable responses, said responses being usable to divide said initial results space.

43. The apparatus of claim 42, wherein said prompt comprises a segmenting prompt having a plurality of potential answers, each answer corresponding to a part of said results space, and each part comprising a substantially proportionate share of said results space.

44. The apparatus of claim 42, wherein generating said prompt comprises
generating a plurality of segmenting prompts, each having a plurality of potential answers, each answer corresponding to a part of said results space, and each part comprising a substantially proportionate share of said results space, and
selecting one of said prompts whose answers most evenly divide said results space.

45. The apparatus of claim 42, further comprising allowing a user to insert additional text, said text being usable as part of said user input by said restrictor.

46. The apparatus of claim 42, wherein said restricting said results space comprises rejecting therefrom any results not corresponding to an answer given in said user input, thereby to generate a revised results space.

47. The apparatus of claim 46, wherein said restrictor is operable to generate at least one further prompt having at least two answers, said answers being selected to divide said revised results space.

48. The apparatus of claim 47, wherein said restrictor is configured to continue said restricting until said refined results space is contracted to a predetermined size.

49. The apparatus of claim 47, wherein said restrictor is configured to continue said restricting until no further prompts are found.

50. The apparatus of claim 47, wherein said restrictor is configured to continue said restricting until a user input is received to stop further restriction and submit the existing results space.

51. The apparatus of claim 50, wherein a user is enabled to respond that a submitted results space does not include a desired item, the apparatus being configured to submit to said user initially retrieved items that have been excluded by said restricting, in receipt of such a response.

52. The apparatus of claim 47, comprising operability to determine that a submitted results space does not include a desired item, the apparatus being configured, following such a determination, to submit to said user initially retrieved items that have been excluded by said restricting, in receipt of such a response.

53. The apparatus of claim 28, wherein said analyzer is configured to receive said initial search criterion as user input.

54. The apparatus of claim 42, wherein said restrictor is configured to provide, with said prompt, a possibility for a user not to select an answer to said prompt.

55. The apparatus of claim 54, wherein said restrictor is operable to provide a further prompt following non-selection of an answer by said user.

56. The apparatus of claim 28, further comprising an updating unit for updating system internal search-supporting information according to a final selection of an item by a user following a query.

57. The apparatus of claim 56, wherein said updating comprises modifying a correlation between said selected item and said obtained user input.

58. The apparatus of claim 56, wherein said updating comprises modifying a correlation between a classification of said selected item and said obtained user input.

59. A database with apparatus for interactive searching thereof to produce a refined results space, the apparatus comprising:
a search criterion analyzer for analyzing for search criteria,
a database searcher, associated with said search criterion analyzer, for searching said database using search criteria to obtain an initial result space, and
a restrictor, for obtaining user input to restrict said results space, and using said user input to restrict said results space, thereby to provide said refined results space.

60. The apparatus of claim 59, wherein said search criterion analyzer comprises a database data-items analyzer capable of producing classifications for data items to correspond with analyzed search criteria.

61. The database of claim 59, wherein said search criterion analyzer comprises a database data-items analyzer capable of utilizing classifications for data items to correspond with analyzed search criteria.

62. The database of claim 60, wherein said database data items analyzer is further capable of utilizing classifications for data items to correspond with analyzed search criteria.

63. The database of claim 59, wherein said search criterion analyzer comprises a search criterion analyzer capable of analyzing user-provided search criteria in terms of a classification structure of items in said database.

64. The database of claim 59, comprising data items and wherein each data item is analyzed into potential search criteria, thereby to optimize matching with user input search criteria.

65. The database of claim 60, wherein said database data items analyzer is operable to carry out linguistic analysis.

66. The database of claim 60, wherein said database data items analyzer is operable to carry out statistical analysis.

67. The database of claim 65, wherein said database data items analyzer is operable to carry out statistical analysis.

68. The database of claim 59, wherein said search criterion analyzer is configured to receive an initial search criterion from a user for said analyzing.

69. The database of claim 68, wherein said initial search criterion is a null criterion.

70. The database of claim 68, wherein said analyzer is configured to carry out linguistic analysis of said initial search criterion.

71. The database of claim 59, wherein said analyzer is configured to carry out an analysis based on selection of related concepts.

72. The database of claim 59, wherein said analyzer is configured to carry out an analysis based on historical knowledge obtained over previous searches.

73. The database of claim 59, wherein said restrictor is operable to generate a prompt for said obtaining user input, said prompt comprising a prompt having at least two answers, said answers being selected to divide said initial results space.

74. The database of claim 73, wherein said prompt is a segmenting prompt having a plurality of potential answers, each answer corresponding to a part of said results space, and each part comprising a substantially proportionate share of said results space.

75. The database of claim 59, further comprising allowing a user to insert additional text, said text being usable as part of said user input by said restrictor.

76. The database of claim 73, wherein said restricting said results space comprises rejecting therefrom any results not corresponding to one of said answers of said user input, thereby to generate a revised results space.

77. The database of claim 76, wherein said restrictor is operable to generate at least one further prompt having at least two answers, said answers being selected to divide said revised results space.

78. The database of claim 77, wherein said restrictor is configured to continue said restricting until said refined results space is contracted to a predetermined size.

79. The database of claim 77, wherein said restrictor is configured to continue said restricting until no further prompts are found.

80. The database of claim 77, wherein said restrictor is configured to continue said restricting until a user input is received to stop further restriction and submit the existing results space.

81. The database of claim 80, wherein said user is enabled to respond that a submitted results space does not include a desired item, the database being operable in receipt of such a response to submit to said user initially retrieved items that have been excluded by said restricting.

82. The database of claim 77, further being operable to determine that a submitted results space does not include a desired item, the database being operable following such a determination to submit to said user initially retrieved items that have been excluded by said restricting.

83. The database of claim 59, wherein said analyzer is configured to receive said initial search criterion as user input.

84. The database of claim 73, wherein said restrictor is configured to provide, with said prompt, a possibility for a user not to select an answer to said prompt.

85. The database of claim 84, wherein said restrictor is further configured to provide an additional prompt following non-selection of an answer by said user.

86. The database of claim 59, further comprising an updating unit for updating system internal search-supporting information according to a final selection of an item by a user following a query.

87. The database of claim 86, wherein said updating comprises modifying a correlation between said selected item and said obtained user input.

88. The database of claim 86, wherein said updating comprises modifying a correlation between a classification of said selected item and said obtained user input.

89. A query method for searching stored data items, the method comprising:
i) receiving a query comprising at least a first search term,
ii) expanding the query by adding to said query, terms related to said at least first search term,
iii) retrieving data items corresponding to at least one of said terms,
iv) using attribute values applied to said retrieved data items to formulate prompts for said user,
v) asking said user at least one of said formulated prompts as a prompt for focusing said query,
vi) receiving a response thereto, and
vii) using said received response to compare to values of said attributes to exclude ones of said retrieved items, thereby to provide a subset of said retrieved data items as a query result.

90. The method of claim 89, wherein said query comprises a plurality of terms, and said expanding said query further comprises analyzing said terms to determine a grammatical interrelationship between ones of said terms.

91. The method of claim 90, further comprising using said grammatical interrelationship to identify leading and subsidiary terms of said search query.

92. The method of claim 89, wherein said expanding comprises a three-stage process of separately adding to said query:
a) items which are closely related to said search term,
b) items which are related to said search term to a lesser degree and
c) an alternative interpretation due to any ambiguity inherent in said search term.

93. The method of claim 92, wherein said items are one of a group comprising lexical terms and conceptual representations.

94. The method of claim 89, further comprising at least one additional focusing process of repeating stages iii) to vi), thereby to provide refined subsets of said retrieved data items as said query result.

95. The method of claim 89, further comprising ordering said formulated prompts according to an entropy weighting based on probability values and asking ones of said prompts having more extreme entropy weightings.

96. The method of claim 95, further comprising recalculating said probability values and consequently said entropy weightings following receiving of a response to an earlier prompt.

97. The method of claim 95, further comprising using a dynamic answer set for each prompt, said dynamic answer set comprising answers associated with classification values, said classification values being true for some received items and false for other received items, thereby to discriminate between said retrieved items.

98. The method of claim 97, further comprising ranking respective answers within said dynamic answer set according to a respective power to discriminate between said retrieved items.

99. The method of claim 95, further comprising modifying said probability values according to user search behavior.

100. The method of claim 99, wherein said user search behavior comprises past behavior of a current user.

101. The method of claim 99, wherein said user search behavior comprises past behavior aggregated over a group of users.

102. The method of claim 99, wherein said modifying comprises using said user search behavior to obtain a priori selection probabilities of respective data items, and modifying said weightings to reflect said probabilities.

103. The method of claim 95, wherein said entropy weighting is associated with at least one of a group comprising said items classifications of said items and respective classification values.

104. The method of claim 89, comprising semantically analyzing said stored data items prior to said receiving a query.

105. The method of claim 89, comprising semantically analyzing said stored data items during a search session.

106. The method of claim 104, wherein said semantic analysis comprises classifying said data items into classes.

107. The method of claim 106, further comprising classifying attributes into attribute classes.

108. The method of claim 106, wherein said classifying comprises distinguishing both among object-classes or major classes, and among attribute classes.

109. The method of claim 108, wherein said classifying comprises providing a plurality of classifications to a single data item.

110. The method of claim 106, wherein a classification arrangement of respective classes is pre-selected for intrinsic meaning to the subject-matter of a respective database.

111. The method of claim 110, comprising arranging major ones of said classes hierarchically.

112. The method of claim 107, comprising arranging attribute classes hierarchically.

113. The method of claim 112, further comprising determining semantic meaning for a term in said data item from a hierarchical arrangement of said term.

114. The method of claim 111, wherein said classes are also used in analyzing said query.

115. The method of claim 110, wherein attribute values are assigned weightings according to the subject-matter of a respective database.

116. The method of claim 110, wherein at least one of said attribute values and said classes are assigned roles in accordance with the subject-matter of a respective database.

117. The method of claim 116, wherein said roles are additionally used in parsing said query.

118. The method of claim 117, further comprising assigning importance weightings in accordance with said assigned roles in accordance with said subject-matter of said database.

119. The method of claim 118, comprising using said importance weightings to discriminate between partially satisfied queries.

120. The method of claim 106, wherein said analysis comprises noun phrase type parsing.

121. The method of claim 106, wherein said analysis comprises using linguistic techniques supported by a knowledge base related to the subject-matter of said stored data items.

122. The method of claim 106, wherein said analysis comprises using statistical classification techniques.

123. The method of claim 106, wherein said analyzing comprises using a combination of:
i) a linguistic technique supported by a knowledge base related to the subject-matter of said stored data items, and
ii) a statistical technique.

124. The method of claim 123, wherein said statistical technique is carried out on a data item following said linguistic technique.

125. The method of claim 123, wherein said linguistic technique comprises at least one of:
segmentation,
tokenization,
lemmatization,
tagging,
part of speech tagging, and
at least partial named entity recognition of said data item.

126. The method of claim 123, further comprising using at least one of probabilities, and probabilities arranged into weightings, to discriminate between different results from said respective techniques.

127. The method of claim 126, further comprising modifying said weightings according to user search behavior.

128. The method of claim 127, wherein said user search behavior comprises past behavior of a current user.

129. The method of claim 127, wherein said user search behavior comprises past behavior aggregated over a group of users.

130. The method of claim 123, wherein an output of said linguistic technique is used as an input to said at least one statistical technique.

131. The method of claim 123, wherein said at least one statistical technique is used within said linguistic technique.

132. The method of claim 123, comprising using two statistical techniques.

133. The method of claim 89, further comprising assigning of at least one code indicative of a meaning associated with at least one of said stored data items, said assignment being to terms likely to be found in queries intended for said at least one stored data item.

134. The method of claim 133, wherein said meaning associated with at least one of said stored data items is at least one of said item, an attribute class of said item and an attribute value of said item.

135. The method of claim 133, further comprising expanding a range of said terms likely to be found in queries by assigning a new term to said at least one code.

136. The method of claim 133, comprising providing groupings of class terms and groupings of attribute value terms.

137. The method of claim 106, wherein, if said analysis identifies an ambiguity, then carrying out a stage of testing said query for semantic validity for each meaning within said ambiguity, and for each meaning found to be semantically valid, presenting said user with a prompt to resolve said validity.

138. The method of claim 106, wherein, if said analysis identifies an ambiguity, then carrying out a stage of testing said query for semantic validity to each meaning within said ambiguity, and for each meaning found to be semantically valid then retrieving data items in accordance therewith and discriminating between said meanings based on corresponding data item retrievals.

139. The method of claim 106, wherein, if said analysis identifies an ambiguity, then carrying out a stage of testing said query for semantic validity to each meaning within said ambiguity, and for each meaning found to be semantically valid, using a knowledge base associated with the subject-matter of said stored data items to discriminate between said semantically valid meanings.

140. The method of claim 89, further comprising predefining for each data item a probability matrix to associate said data item with a set of attribute values.

141. The method of claim 140, further comprising using said probabilities to resolve ambiguities in said query.

142. The method of claim 89, further comprising a stage of processing input text comprising a plurality of terms relating to a predetermined set of concepts, to classify said terms in respect of said concepts, the stage comprising
arranging said predetermined set of concepts into a concept hierarchy,
matching said terms to respective concepts, and
applying further concepts hierarchically related to said matched concepts, to said respective terms.

143. The method of claim 142, wherein said concept hierarchy comprises at least one of the following relationships
(a) a hypernym-hyponym relationship,
(b) a part-whole relationship,
(c) an attribute value dimension—attribute value relation,
(d) an inter-relationship between neighboring conceptual sub-hierarchies.

144. The method of claim 142, wherein said classifying said terms further comprises applying confidence levels to rank said matched concepts according to types of decisions made to match respective concepts.

145. The method of claim 142, further comprising
identifying prepositions within said text,
using relationships of said prepositions to said terms to identify a term as a focal term, and
setting concepts matched to said focal term as focal concepts.

146. The method of claim 142, wherein said arranging said concepts comprises grouping synonymous concepts together.

147. The method of claim 146, wherein said grouping of synonymous concepts comprises grouping of concept terms being morphological variations of each other.

148. The method of claim 142, wherein at least one of said terms has a plurality of meanings, the method comprising a disambiguation stage of discriminating between said plurality of meanings to select a most likely meaning.

149. The method of claim 148, wherein said disambiguation stage comprises comparing at least one of attribute values, attribute dimensions, brand associations and model associations between said input text and respective concepts of said plurality of meanings.

150. The method of claim 149, wherein said comparing comprises determining statistical probabilities.

151. The method of claim 148, wherein said disambiguation stage comprises identifying a first meaning of said plurality of meanings as being hierarchically related to another of said terms in said text, and selecting said first meaning as said most likely meaning.

152. The method of claim 148, comprising retaining at least two of said plurality of meanings.

153. The method of claim 152, further comprising applying probability levels to each of said retained meanings, thereby to determine a most probable meaning.

154. The method of claim 148, further comprising finding alternative spellings for at least one of said terms, and applying each alternative spelling as an alternative meaning.

155. The method of claim 154, further comprising using respective concept relationships to determine a most likely one of said alternative spellings.

156. The method of claim 142, wherein said input text is an item to be added to a database.

157. The method of claim 142, wherein said input text is a query for searching a database.

158. A query method for searching stored data items, the method comprising:
receiving a query comprising at least a first search term from a user,
expanding the query by adding to said query, terms related to said at least first search term,
analyzing said query for ambiguity,
formulating at least one ambiguity-resolving prompt for said user, such that an answer to said prompt resolves said ambiguity,
modifying said query in view of an answer received to said ambiguity resolving prompt,
retrieving data items corresponding to said modified query,
formulating results-restricting prompts for said user,
selecting at least one of said results-restricting prompts to ask said user, and receiving a response thereto
using said received response to exclude ones of said retrieved items, thereby to provide to said user a subset of said retrieved data items as a query result.

159. The method of claim 158, wherein said query comprises a plurality of terms, and said expanding said query further comprises analyzing said terms to determine a grammatical interrelationship between ones of said terms.

160. The method of claim 158, wherein said expanding comprises a three-stage process of separately adding to said query:
a) items which are closely related to said search term,
b) items which are related to said search term to a lesser degree and
c) an alternative interpretation due to any ambiguity inherent in said search term.

161. The method of claim 158, further comprising at least one additional focusing process of repeating stages iii) to vi), thereby to provide refined subsets of said retrieved data items as said query result.

162. The method of claim 158, further comprising ordering said formulated prompts according to an entropy weighting based on probability values and asking ones of said prompt having more extreme entropy weightings.

163. The method of claim 162, further comprising recalculating said probability values and consequently said entropy weightings following receiving of a response to an earlier prompt.

164. The method of claim 162, further comprising using a dynamic answer set for each prompt, said dynamic answer set comprising answers associated with attribute values, said attribute values being true for some received items and false for other received items, thereby to discriminate between said retrieved items.

165. The method of claim 164, further comprising ranking respective answers within said dynamic answer set according to a respective power to discriminate between said retrieved items.

166. The method of claim 162, further comprising modifying said probability values according to user search behavior.

167. The method of claim 166, wherein said user search behavior comprises past behavior of a current user.

168. The method of claim 166, wherein said user search behavior comprises past behavior aggregated over a group of users.

169. The method of claim 166, wherein said modifying comprises using said user search behavior to obtain a priori selection probabilities of respective data items, and modifying said weightings to reflect said probabilities.

170. The method of claim 162, wherein said entropy weighting is associated with at least one of a group comprising said items, classifications and classification values of respective attributes.

171. The method of claim 158, comprising semantically parsing said stored data items prior to said receiving a query.

172. The method of claim 171, wherein said semantic analysis prior to querying comprises pre-arranging said data items into classes, each class having assigned attribute values, the pre-arranging comprising analyzing said data item to identify therefrom a data item class and if present, attribute values of said class.

173. The method of claim 172, comprising arranging said attribute values into classes.

174. The method of claim 172, wherein said classes are pre-selected for intrinsic meaning to subject matter of a respective database.

175. The method of claim 174, wherein major ones of said classes are arranged hierarchically.

176. The method of claim 173, wherein said attribute classes are arranged hierarchically.

177. The method of claim 176, further comprising determining semantic meaning to a term in said data item from a hierarchical arrangement of said term.

178. The method of claim 175, wherein said classes are also used in analysing said query.

179. The method of claim 174, wherein attribute values are assigned weightings according to the subject-matter of a respective database.

180. The method of claim 174, wherein at least one of said attribute values and said classes are assigned roles in accordance with the subject matter of a respective database.

181. The method of claim 180, wherein said roles are additionally used in parsing said query.

182. The method of claim 181, further comprising assigning importance weightings in accordance with said assigned roles in accordance with said subject-matter.

183. The method of claim 182, comprising using said importance weightings to discriminate between partially satisfied queries.

184. The method of claim 172, wherein said analyzing comprises noun phrase type parsing.

185. The method of claim 172, wherein said analyzing comprises using linguistic techniques supported by a knowledge base related to the subject-matter of said stored data items.

186. The method of claim 172, wherein said analyzing comprises statistical classification techniques.

187. The method of claim 172, wherein said analyzing comprises using a combination of:
i) a linguistic technique supported by a knowledge base related to the subject-matter of said stored data items, and
ii) a statistical technique.

188. The method of claim 187, wherein said statistical technique is carried out on a data item following said linguistic technique.

189. The method of claim 187, wherein said linguistic technique comprises at least one of:
segmentation,
tokenization,
lemmatization,
tagging,
part of speech tagging, and
at least partial named entity recognition of said data item.

190. The method of claim 187, further comprising using at least one of probabilities, and probabilities arranged into weightings, to discriminate between different results from said respective techniques.

191. The method of claim 190, further comprising modifying said weightings according to user search behavior.

192. The method of claim 191, wherein said user search behavior comprises past behavior of a current user.

193. The method of claim 191, wherein said user search behavior comprises past behavior aggregated over a group of users.

194. The method of claim 187, wherein an output of said linguistic technique is used as an input to said at least one statistical technique.

195. The method of claim 187, wherein said at least one statistical technique is used within said linguistic technique.

196. The method of claim 187, comprising using two statistical techniques.

197. The method of claim 158, further comprising assigning of at least one code indicative of a meaning associated with at least one of said stored data items, said assignment being to terms likely to be found in queries intended for said at least one stored data item.

198. The method of claim 197, wherein said meaning associated with at least one of said stored data items is at least one of said item, a classification of said item and classification value of said item.

199. The method of claim 197, further comprising expanding a range of said terms likely to be found in queries by assigning a new term to said at least one code.

200. The method of claim 197, comprising providing groupings of class terms and groupings of attribute value terms.

201. The method of claim 172, wherein, if said analyzing identifies an ambiguity, then carrying out a stage of testing said query for semantic validity for each meaning within said ambiguity, and for each meaning found to be semantically valid, presenting said user with a prompt to resolve said validity.

202. The method of claim 172, wherein, if said analyzing identifies an ambiguity, then carrying out a stage of testing said query for semantic validity to each meaning within said ambiguity, and for each meaning found to be semantically valid then retrieving data items in accordance therewith and discriminating between said meanings based on corresponding data item retrievals.

203. The method of claim 172, wherein, if said analyzing identifies an ambiguity, then carrying out a stage of testing said query for semantic validity to each meaning within said ambiguity, and for each meaning found to be semantically valid, using a knowledge base associated with the subject-matter of said stored data items to discriminate between said semantically valid meanings.

204. The method of claim 158, further comprising predefining for each data item a probability matrix to associate said data item with a set of attribute values.

205. The method of claim 204, further comprising using said probabilities to resolve ambiguities in said query.

206. A query method for searching stored data items, the method comprising:
receiving a query comprising at least two search terms from a user,
analyzing the query by determining a semantic relationship between the search terms thereby to distinguish between terms defining an item and terms defining an attribute value thereof,
retrieving data items corresponding to at least one of identified items,
using attribute values applied to said retrieved data items to formulate prompts for said user,
asking said user at least one of said formulated prompts and receiving a response thereto
using said received response to compare to values of said attributes to exclude ones of said retrieved items, thereby to provide to said user a subset of said retrieved data items as a query result.

207. The method of claim 206, wherein said analyzing the query comprises applying confidence levels to rank said terms according to types of decisions made to reach said terms.

208. A query method for searching stored data items, the method comprising:
receiving a query comprising at least a first search term from a user,
parsing said query to detect noun phrases,
retrieving data items corresponding to said parsed query,
formulating results-restricting prompts for said user,
selecting at least one of said results-restricting prompts to ask a user, and receiving a response thereto
using said received response to exclude ones of said retrieved items, thereby to provide to said user a subset of said retrieved data items as a query result.

209. The query method of claim 208, wherein said parsing comprises identifying:
i) references to stored data items in said query, and
ii) references to at least one of attribute classes and attribute values associated therewith.

210. The query method of claim 209, further comprising assigning importance weights to respective attribute values, said importance weights being usable to gauge a level of correspondence with data items in said retrieving.

211. The query method of claim 208, further comprising ranking said results-restricting prompts and only asking said user highest ranked ones of said prompts.

212. The query method of claim 211, wherein said ranking is in accordance with an ability of a respective prompt to modify a total of said retrieved items.

213. The query method of claim 211, wherein said ranking is in accordance with weightings applied to attribute values to which respective prompts relate.

214. The query method of claim 211, wherein said ranking is in accordance with experience gathered in earlier operations of said method.

215. The query method of claim 214, wherein said experience is at least one of a group comprising experience over all users, experience over a group of selected users, experience from a grouping of similar queries, and experience gathered from a current user.

216. The query method of claim 211, wherein said formulating comprises framing a prompt in accordance with a level of effectiveness in modifying a total of said retrieved items.

217. The query method of claim 211, wherein said formulating comprises weighting attribute values associated with data items of said query and framing a prompt to relate to highest ones of said weighted attribute values.

218. The query method of claim 211, wherein said formulating comprises framing prompts in accordance with experience gathered in earlier operations of said method.

219. The query method of claim 218, wherein said experience is at least one of a group comprising experience over all users, experience gathered from a predetermined group of users, experience gathered from a group of similar queries and experience gathered from a current user.

220. The query method of claim 211, wherein said formulating comprises including a set of at least two answers based on said retrieved results, each answer mapping to at least one retrieved result.

221. An automatic method of classifying stored data relating to a set of objects for a data retrieval system, the method comprising:
defining at least two object classes,
assigning to each class at least one attribute value,
for each attribute value assigned to each class assigning an importance weighting,
assigning objects in said set to at least one class, and
assigning to said object, an attribute value for at least one attribute of said class.

222. The method of claim 221, wherein said objects are represented by textual data and wherein said assigning of objects and assigning of said attribute values comprise using a linguistic algorithm and a knowledge base.

223. The method of claim 221, wherein said objects are represented by textual data and wherein said assigning of objects and assigning of said attribute values comprise using a combination of a linguistic algorithm, a knowledge base and a statistical algorithm.

224. The method of claim 221, wherein said objects are represented by textual data and wherein said assigning of objects and assigning of said attribute values comprise using supervised clustering techniques.

225. The method of claim 224, wherein said supervised clustering comprises initially assigning using a linguistic algorithm and a knowledge base and subsequently adding statistical techniques.

226. The method of claim 221, further comprising providing an object taxonomy within at least one class.

227. The method of claim 221, further comprising providing an attribute value taxonomy within at least one attribute.

228. The method of claim 221, comprising grouping query terms having a similar meaning in respect of said object classes under a single label.

229. The method of claim 221, further comprising grouping attribute values to form a taxonomy.

230. The method of claim 229, wherein said taxonomy is global to a plurality of object classes.

231. The method of claim 221, wherein said objects are represented by textual descriptions comprising a plurality of terms relating to a predetermined set of concepts, the method comprising a stage of analyzing said textual descriptions, to classify said terms in respect of said concepts, the stage comprising
arranging said predetermined set of concepts into a concept hierarchy,
matching said terms to respective concepts, and
applying further concepts hierarchically related to said matched concepts, to said respective terms.

232. The method of claim 231, wherein said concept hierarchy comprises at least one of the following relationships
(a) a hypernym-hyponym relationship,
(b) a part-whole relationship,
(c) an attribute dimension—attribute value relation,
(d) an inter-relationship between neighboring conceptual sub-hierarchies.

233. The method of claim 231, wherein said classifying said terms further comprises applying confidence levels to rank said matched concepts according to types of decisions made to match respective concepts.

234. The method of claim 231, further comprising
identifying prepositions,
using relationships of said prepositions to said terms to identify a term as a focal term, and
setting concepts matched to said focal term as focal concepts.

235. The method of claim 231, wherein said arranging said concepts comprises grouping synonymous concepts together.

236. The method of claim 235, wherein said grouping of synonymous concepts comprises grouping of concept terms being morphological variations of each other.

237. The method of claim 231, wherein at least one of said terms has a plurality of meanings, the method comprising a disambiguation stage of discriminating between said plurality of meanings to select a most likely meaning.

238. The method of claim 237, wherein said disambiguation stage comprises comparing at least one of attribute values, attribute dimensions, brand associations and model associations between said terms and respective concepts of said plurality of meanings.

239. The method of claim 238, wherein said comparing comprises determining statistical probabilities.

240. The method of claim 237, wherein said disambiguation stage comprises identifying a first meaning of said plurality of meanings as being hierarchically related to another of said terms, and selecting said first meaning as said most likely meaning.

241. The method of claim 237, comprising retaining at least two of said plurality of meanings.

242. The method of claim 241, further comprising applying probability levels to each of said retained meanings, thereby to determine a most probable meaning.

243. The method of claim 237, further comprising finding alternative spellings for at least one of said terms, and applying each alternative spelling as an alternative meaning.

244. The method of claim 243, further comprising using respective concept relationships to determine a most likely one of said alternative spellings.

245. A method of processing input text comprising a plurality of terms relating to a predetermined set of concepts, to classify said terms in respect of said concepts, the method comprising
arranging said predetermined set of concepts into a concept hierarchy,
matching said terms to respective concepts, and
applying further concepts hierarchically related to said matched concepts, to said respective terms.

246. The method of claim 245, wherein said concept hierarchy comprises at least one of the following relationships
(a) a hypernym-hyponym relationship,
(b) a part-whole relationship,
(c) an attribute dimension—attribute value relation,
(d) an inter-relationship between neighboring conceptual sub-hierarchies.

247. The method of claim 245, wherein said classifying said terms further comprises applying confidence levels to rank said matched concepts according to types of decisions made to match respective concepts.

248. The method of claim 245, further comprising
identifying prepositions within said text,
using relationships of said prepositions to said terms to identify a term as a focal term, and
setting concepts matched to said focal term as focal concepts.

249. The method of claim 245, wherein said arranging said concepts comprises grouping synonymous concepts together.

250. The method of claim 249, wherein said grouping of synonymous concepts comprises grouping of concept terms being morphological variations of each other.

251. The method of claim 245, wherein at least one of said terms comprises a plurality of meanings, the method comprising a disambiguation stage of discriminating between said plurality of meanings to select a most likely meaning.

252. The method of claim 251, wherein said disambiguation stage comprises comparing at least one of attribute values, attribute dimensions, brand associations and model associations between said input text and respective concepts of said plurality of meanings.

253. The method of claim 252, wherein said comparing comprises determining statistical probabilities.

254. The method of claim 251, wherein said disambiguation stage comprises identifying a first meaning of said plurality of meanings as being hierarchically related to another of said terms in said text, and selecting said first meaning as said most likely meaning.

255. The method of claim 251, comprising retaining at least two of said plurality of meanings.

256. The method of claim 255, further comprising applying probability levels to each of said retained meanings, thereby to determine a most probable meaning.

257. The method of claim 251, further comprising finding alternative spellings for at least one of said terms, and applying each alternative spelling as an alternative meaning.

258. The method of claim 257, further comprising using respective concept relationships to determine a most likely one of said alternative spellings.

259. The method of claim 245, wherein said input text is an item to be added to a database.

260. The method of claim 245, wherein said input text is a query for searching a database.
